(19) United States
(12) Patent Application Publication
(10) Pub. No.: US 2011/0206127 A1
(43) Pub. Date: Aug. 25, 2011

(54) Method and Apparatus of Frame Interpolation

(75) Inventors: Ngoc-Lân NGUYEN, Laval (CA); Chang SU, Saint-Laurent (CA); Chao WU, Vaughan (CA)

(73) Assignee: SENSIO TECHNOLOGIES INC., Montreal (CA)

(21) Appl. No.: 13/022,631

(22) Filed: Feb. 8, 2011

Related U.S. Application Data
(63) Continuation of application No. PCT/CA2011/050068, filed on Feb. 7, 2011.
(60) Provisional application No. 61/301,714, filed on Feb. 5, 2010.

(51) Int. Cl. H04N 7/26

(52) U.S. Cl. 375/240.16; 375/E07.125

(57) ABSTRACT

Methods and an apparatus for interpolating a digital image frame located between a first anchor frame and a second target frame are described. The apparatus comprises a motion vector estimator unit for estimating a block-based motion vector and a corresponding variable-size sub-block motion vector based on, and between, the first anchor frame and the second target frame; and a motion compensation interpolation unit for interpolating the digital image frame from the corresponding variable-size sub-block motion vector.

### TECHNICAL FIELD

The present invention relates to a digital video processing, particularly to a reliable and real-time generation of interpolated frames for frame rate conversions. It includes a method and apparatus of estimating motions from inputs frames and, a method and apparatus for interpolating intermediate frames based on the motions estimated.

### BACKGROUND

Frame rate conversion (FRC) is an operation that changes the frame rate of a given video sequence by having more (or fewer) images shown per second than what is originally captured from cameras or available from a source. This need rises from the fact that conversion to and from various refresh standards exist (e.g. PAL to NTSC or vice versa) and also, when viewing some video materials like sport scenes or action movies, a higher frame rate is desirable to insure smooth movements of objects to human eyes. Examples are high definition LCD with higher refresh rates available (120 Hz) that uses the FRC for displaying original 60 Hz video sequences to give a more fluid motion effect. Different video content with 24, 30, 50 or 60 frames per second (fps) needs the FRC to achieve such conversions. Another important application for FRC is the super-slow motion used to slow down fast movements from some scenes like sport or action movies. Although there exist some high speed cameras capable of capturing thousands or millions of frames per second; such cameras are however very expensive and are not suitable for typical applications. The third important use of the FRC is in the communication domain. To save on transmission bandwidth, one can drop frames from an original video sequence before the encoding process and once decoded, the dropped frames can be interpolated back by the FRC. Such process can have an important impact in communications, but due to the lack of reliable FRC, this idea has a rather limited use.

There currently exist two main alternative methods for generating missing frames during FRC. The drop/repeat method, also known as replication, and the motion based interpolation method.

Replication is a simple and easy solution for FRC. An example is the famous 2:3 pull down or 2:2 pull down process to convert from film sequences to 60 fps or 50 fps which are displayable on consumer television sets. Although this approach is simple enough, it may however introduce jumpy and judder effects. To alleviate this jumpy effect, U.S. Pat. No. 7,206,062 B2 uses motion detection to chose between field duplication or frame duplication.

The motion compensated interpolation is more challenging, especially for real-time applications. In U.S. Patent Application 2006/0104352 A1, block matching is carried out in a frequency domain (DCT transform), which generally requires less computation than if carried out in the spatial domain. Another popular frequency domain block matching is the so called Phase Plane Correlation (PPC) as described in U.S. Pat. No. 7,197,074 B2. The PPC uses a Fast Fourier Transform (FFT) which generates complex coefficients composed of a real part that represents the amplitude and a virtual part that represents the phase. Since the phase has physical meaning as a spatial shift of a block, a motion vector can be detected by an inverse FFT (IFFT) from the phase plane. During the IFFT, the candidate block is shifted. When the correlation of the phase plane reaches a peak, the shifted block has the most similarity to the reference block. Therefore, the corresponding phase would be the correct motion vector. The strength of PPC is that it actually measures the direction and speed of moving objects. Therefore, PPC has its advantages over spatial motion estimation in catching global motions and avoiding local traps. Generally, PPC is capable of detecting fast moving objects and correct matching the image with regular pattern or structure and robustness of the occlusion regions. FFT is however complex and costly to implement.

U.S. Pat. No. 7,586,540 B2 uses the pixel-based motion estimation to detect the movement of objects for a display panel. However, pixel-based motion estimation can lead to serious visual artefacts since signal noise is common in real life video sequences and can quickly degrade estimation results; also, it is expensive to implement efficiently. Time-consuming pixel estimation can be reduced with the help of pixel analysis. In U.S. Publication no. 2009/0161763, a statistic pattern of a pixel in a spatial domain is analyzed and only highly textured ones are estimated.

Although pixel-based motion compensation works fine with frame rate conversion, since the normal display speed (rate) can dupe the human vision system and thereby, can partially mask some easily identifiable distortions, it is not suitable for the super-slow motion with fast movements, complex objects, and slower frame rates.

Most solutions for FRC resort to block-based motion estimation (ME) and motion compensated interpolation (MCI). The block-based interpolation faces many challenges in terms of artifacts including the halo effect, flicker, blurring, judder, object doubling and block artifacts. Many methods have been proposed to correct these artifacts (U.S. Pat. No. 6,005,639; U.S. Pat. No. 6,011,596; U.S. Pat. No. 7,010,039). However, these advanced techniques involve analysis of more than two frames, amount of data which significantly increases requirements for image memories and are computationally inefficient.

Two-frame solutions have been proposed that are based on motion vector (MV) correction, interpolation strategies and/or mixing of these two methods. In U.S. Patent Publication No. 2009/161010, two interpolated images are generated. An interpolator is coupled to receive the first interpolated image that corrects the motion vectors to form a second interpolated image. The two processes approach inevitably introduces delay. Moreover, different techniques have been adopted to correct the motion vectors since the roots of the problem may come from different artifacts.

Accordingly, there is a need for a frame interpolation method and apparatus which addresses the limitations associated with the prior art.

### SUMMARY

Since the artifacts are generated due to different reasons, the motion vector correction could be quite complicated and quite often not suitable for real-time application. In the present description, the various artifacts are addressed via another approach. First, the motion correction is addressed (moved) in advance. Instead of trying to correct the motion vector after the initial Motion Estimation (ME), in accordance with the proposed solution, the ME employed provides a robust motion vector. Three motion estimators: unilateral, bilateral and Global-Like Motion Estimator (GLME), along with a variable-size block estimator, are executed in ME. From these motion vectors, a motion selector picks the final motion vector. After ME, no efforts are needed to correct the motion vectors. An alleviation effort to reduce the impact of the artifacts is further made during Motion Compensation (MC). Notably, no attempt is being made to distinguish between artifacts and treat them separately. The interpolated image generated by the motion vectors is reversely mapped back to the anchor/target frames. By comparing differences in corresponding pixels in an interpolated frame and anchor/target frames, a pixel-based mask is generated. Each marked pixel is then softened by the overlapped-block compensation. The overlapped-block compensation combines information from adjacent blocks and improves the visual quality of the pixel without considering (acknowledging) artifact types.

A component of FRC described herein is the interpolator, which generate an interpolated frame between two original frames. In accordance with the proposed solution, the interpolator includes a Motion Estimator (ME) that provides the block-based motion vectors and the corresponding estimation errors; a motion selector coupled to a bilateral motion estimator and a unilateral motion estimator is used for selecting a reliable motion vector(s); a Motion Compensator (MC) configured to receive the motion vectors generates initial interpolated frames; a reverse mapping component operates on the interpolated frame, the two original frames and the motion vectors to provide a pixel-based robustness mask; a overlapped block compensation component is employs to the pixel-based robust mask to reduce halo effects in occlusion regions of initial interpolated frames.

The FRC described herein has many important applications for the TV broadcast domain, including the transfer between different formats and addressing artifacts of super slow motion for sports. It can also be a great tool in communications domain where video transmission bandwidth is a limiting factor. The present description aims to greatly improve motion estimation and frame interpolation used in FRCS. As such, the herein described FRC attempts to address at least the following advantages:

Hardware Friendly and Efficient for Real-Time Applications.

Provide a robust set of Motion Vectors (MV) by employing motion processing not just in a common luminance domain, but also in additional image transform domains to ensure MV robustness, and further by combining three efficient strategies of motion estimation namely, unilateral motion estimation, bilateral motion estimation and Global-Like Motion Estimation (GLME). Combining the three motion estimations for sub-blocks with a proposed reverse mapping technique which provides a robustness mask, the present method provides motion vectors which are more faithful to reality than existing prior art approaches described above.

Robust motion vectors can greatly improve the interpolation results. Moreover, in accordance with the proposed solution, an Overlapped Block Compensation (OBC) method combined with an intelligent decision making algorithm provides frame interpolation with reduced blockiness, blinking or other (obvious) perceptible distortions for the human eye. The OBC is also a suitable tool to address occlusion distortions, distortions which are most encountered with common motion compensation based interpolations; and the use of intelligent decision making ensures retaining the sharpness of interpolated results.

The presently proposed frame interpolation is also suitable for both frame rate conversion and slow motion applications.

Accordingly, the present description provides, in an embodiment, an apparatus for interpolating a digital image frame located between a first anchor frame and second adjacent target frame. The apparatus comprises a motion vector estimator component for estimating a block-based motion vector and a corresponding variable-size sub-block motion vector based on, and between the first anchor frame and the second adjacent target frame; and a motion compensation interpolation component for interpolating the digital image frame from the corresponding variable-size sub-block motion vector.

In accordance with another embodiment, there is provided a method of interpolating a digital image frame located between a first anchor frame and second adjacent target frame. The method comprises estimating a block-based motion vector and a corresponding variable-size sub-block motion vector based on, and between the first anchor frame and the second adjacent target frame; and interpolating the digital image frame from the corresponding variable-size sub-block motion vector.

In one embodiment, the above estimating comprises: generating an initial motion vector using a fast three-step hexagonal pattern; dynamically setting a search window size for use with a full search pattern based on the initial motion vector; and generating a final motion vector using the full search pattern, the final motion vector being indicative of the corresponding variable-size sub-block motion vector.

In one embodiment, the above hexagonal pattern has a directionally more uniform distribution than the traditional rectangular shape.

In one embodiment, the above search window size is adaptively shrunk or expanded according to the initial estimation results, which provides a dynamic performance.

In one embodiment, the above full search pattern estimates the block-based three level variable-size sub-block motion vectors, including the generation of additional image transform measures for use in a similarity measure; the unilateral estimator; the bilateral estimator; the GLME; an unified reusable motion estimator module for both unilateral and bilateral estimator, which generates three level motion vectors in one round motion search; a motion vector selector to pick a motion vector from either one the unilateral estimator and bilateral estimator; a motion vector conformer operates on the motion vector and the variable-size block motion vector to give a uniform motion field.

In one embodiment, all the three-level motion vectors are conformed to give a smooth and consistent motion field.

In one embodiment, the above motion compensation interpolation unit performs the following steps: calculating the motion movement for the anchor frame and target frame to get the proper blocks for constructing the first initial interpolated frame; reverse mapping the first frame back to the anchor and target frames to generate a pixel-based mask frame; replacing the masked pixels in the first frame with those from overlapped block compensations.

In one embodiment, the pixel-based mask frame is generated by calculating the motion movement for the initial interpolated frame to anchor and target frame respectively; pixel-by-pixel comparing the interpolated frame and original frames and storing the marked pixel in the mask frame; and post-processing of the mask frame such as erosion to give a smooth mask frame.

In one embodiment, a pixel in the mask frame is replaced by the overlapped block compensation, which involves generating a set of overlapped windows with different shapes; collecting the proper pixels from eight adjacent blocks; according to the estimation error, choosing the proper overlapped window to combine corresponding pixels from different blocks; and replacing the marked pixels in the first interpolated frame with the one generated by the overlapped-block compensation.

In one embodiment, the overlapped window is generated by the Kaiser-Bessel derived (KBD) window, with adjustable shape factor α.

In accordance with an aspect of the proposed solution there is provided a method for generating a motion vector between an anchor frame and a target frame of an image stream, said method comprising: defining a plurality of blocks at least in said anchor frame; obtaining a coarse block-based motion vector estimate for each anchor frame block by comparing image information in each anchor frame block to image information in said target frame using in an overall pentagonal or higher pattern about a center position; and obtaining at least one refined final motion vector by comparing image information in each said anchor frame block to image information in said target frame about said block-based motion vector estimate.

In accordance with another aspect of the proposed solution there is provided a method for generating a motion vector between an anchor frame and a target frame of an image stream, said method comprising: defining a plurality of blocks at least in said anchor frame; obtaining a coarse block-based motion vector estimate for each anchor frame block; providing a search window based on the motion vector estimate; and obtaining at least one refined final motion vector in a window having said corresponding search window size.

In accordance with a further aspect of the proposed solution there is provided a method for generating a motion vector between an anchor frame and a target frame of an image stream, said method comprising: defining a plurality of blocks at least in said anchor frame; and obtaining at least one motion vector by comparing image information in each said anchor frame block to image information in said target frame about a block-based motion vector estimate employing a plurality of motion estimators, each motion estimator having different properties under different conditions, each motion estimator providing a measure of motion estimation error, wherein one of said plurality of motion estimators is used based on a minimized motion estimation error to improve motion estimation reliability.

In accordance with a further aspect of the proposed solution there is provided a method for generating a motion vector between an anchor frame and a target frame of an image stream, said method comprising: defining a plurality of blocks at least in said anchor frame; and obtaining at least one block-based motion vector for each anchor frame block by comparing image information in each anchor frame block to image information in said target frame, said image information including image luminance and at least one image transform for identifying similarity measures between said anchor frame and said target frame.

In accordance with a further aspect of the proposed solution there is provided a method for interpolating at least one image between an anchor frame and a target frame of an image stream having an initial frame rate, said method comprising: defining a plurality of blocks at least in said anchor frame; obtaining at least one block-based motion vector for each anchor frame block by comparing image information in each anchor frame block to image information in said target frame; generating at least one trial interpolated frame based on said at least one motion vector, said trial interpolated frame having a plurality of blocks; identifying pixel interpolation errors to detect pixels associated with interpolation artifacts; and regenerating pixels exhibiting interpolation artifacts based on image information from interpolated frame blocks adjacent to pixels exhibiting artifacts to minimize said interpolation artifacts.

In accordance with yet another aspect of the proposed solution there is provided an apparatus employing a method in accordance with the above identified aspects of the proposed solution.

### BRIEF DESCRIPTION OF THE DRAWINGS

Further features and advantages of the present disclosure will become apparent from the following detailed description, taken in combination with the appended drawings, in which:

FIG. 1 is an illustration of an arbitrary rational frame rate conversion, in accordance with an embodiment of the proposed solution.

FIG. 2 is an illustration of a block-based motion estimation used to reconstruct the interpolated image, in accordance with an embodiment of the proposed solution.

FIG. 3 is a schematic diagram illustrating a block-based FRC, in accordance with an embodiment;

FIG. 4 is a schematic diagram illustrating the motion estimator of FIG. 3, in accordance with an embodiment of the proposed solution.

FIG. 5 is an illustrative example of steps performed by a fast hexagonal search module of FIG. 4, in accordance with an embodiment of the proposed solution.

FIG. 6 is a schematic diagram illustrating a dynamic search range module of FIG. 4, in accordance with an embodiment of the proposed solution.

FIG. 7 is a schematic diagram illustrating the full search motion estimator module of FIG. 4, in accordance with an embodiment of the proposed solution.

FIG. 8 is a schematic illustration of a three-level variable-size block technique implemented by the estimators of FIG. 7, in accordance with an embodiment of the proposed solution.

FIG. 9 is a schematic block diagram illustrating components of the estimators of FIG. 7 for realizing a variable-size block motion estimation as per FIG. 8, in accordance with an embodiment of the proposed solution.

FIG. 10 is a schematic diagram illustrating the motion selector of FIG. 7, in accordance with an embodiment of the proposed solution.

FIG. 11 is a schematic diagram illustrating the motion compensation interpolator module of FIG. 3, in accordance with an embodiment of the proposed solution.

FIG. 12 is an example schematically illustrating a reverse mapping technique implemented by reverse prediction component of FIG. 11, in accordance with an embodiment of the proposed solution.

FIG. 13 is a schematic diagram illustrating the overlapped block compensation module of FIG. 11, in accordance with an embodiment of the proposed solution.

FIG. 14a is an example schematically illustrating adjacent blocks involved in the overlapped-block compensation technique implemented by the OBC module of FIG. 13, with a center block and four corner neighbor blocks, in accordance with an embodiment of the proposed solution;

FIG. 14b is an example schematically illustrating adjacent blocks involved in the overlapped-block compensation technique implemented by the OBC module of FIG. 13, with a center block and two vertical neighbor blocks, in accordance with an embodiment of the proposed solution;

FIG. 14c is an example schematically illustrating adjacent blocks involved in the overlapped-block compensation technique implemented by the OBC module of FIG. 13, with a center block and two horizontal neighbor blocks, in accordance with an embodiment of the proposed solution;

FIG. 15 is a schematic illustration of an overlapped window as per the above technique in FIGS. 14a, b and c, in accordance with an embodiment of the proposed solution;

FIG. 16a and FIG. 16b are schematic illustrations of examples of the overlapped window of FIG. 15, with different alpha a values, in accordance with an embodiment of the proposed solution;

FIG. 17 is a schematic illustration of a big and small extending techniques implemented for estimators of FIG. 7, in accordance with another embodiment of the proposed solution;

FIG. 18 is a schematic illustration of another three-level variable-size block technique implemented by the estimators of FIG. 7, in accordance with another embodiment of the proposed solution;

FIG. 19 is a schematic block diagram illustrating components of estimators of FIG. 7 for realizing a variable-size block motion estimation as per FIGS. 17 and/or 18, in accordance with another embodiment;

FIG. 20 is a schematic diagram of the motion selector of FIG. 7, in accordance with another embodiment of the proposed solution;

FIG. 21 is a schematic illustration of a block edge detection technique implemented in the block edge comparison module of FIG. 20, in accordance with another embodiment of the proposed solution;

It will be noted that throughout the appended drawings, like features are typically identified by like reference numerals.

### DETAILED DESCRIPTION

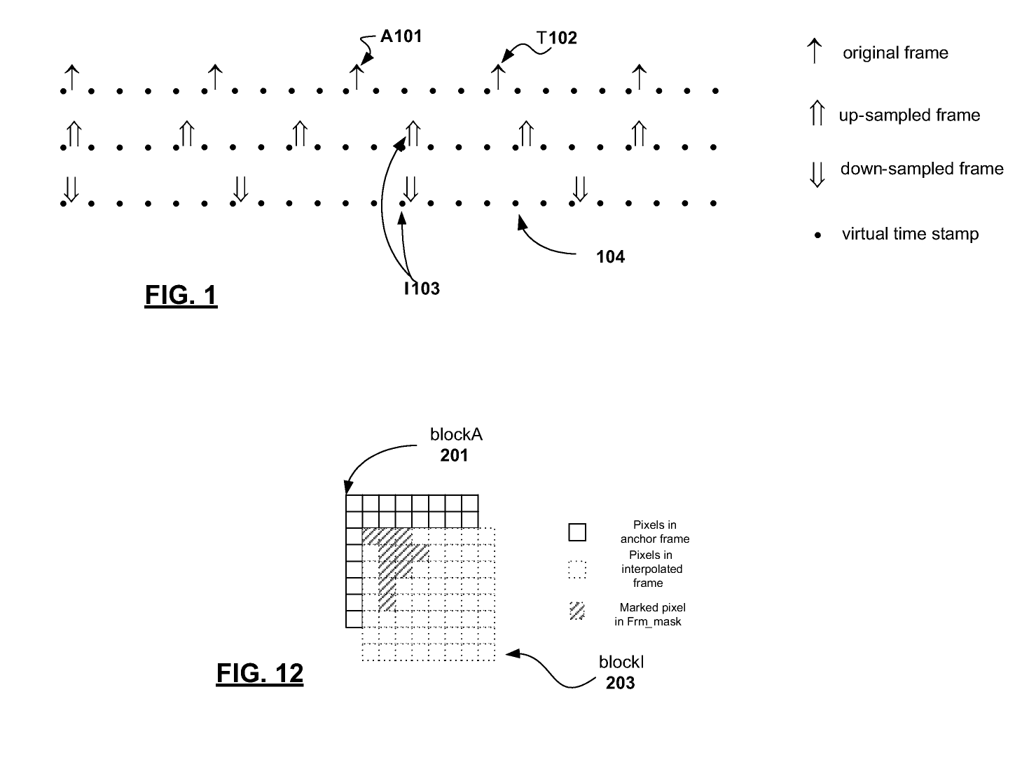

The proposed Frame Rate Conversion (FRC) provides conversion between arbitrary rational frame rates. The following description assumes the frame rate conversion ratio to be r1/r2, as illustrated for example in FIG. 1. The original sequence is first up-sampled at r2, which inserts r2-1 virtual time stamps between two consecutive frames. Then, by down-sampling the virtual time stamp by r1 times, we have the converted frame rate of the output sequence. If r1>r2 , the result is an up-sampled frame rate conversion and vice versa for the down-sampled frame rate conversion. An interpolated frame I 103 is generated between the first (earlier) frame, called the anchor frame A 101, and the second (later/subsequent) frame, called the target frame T 102.

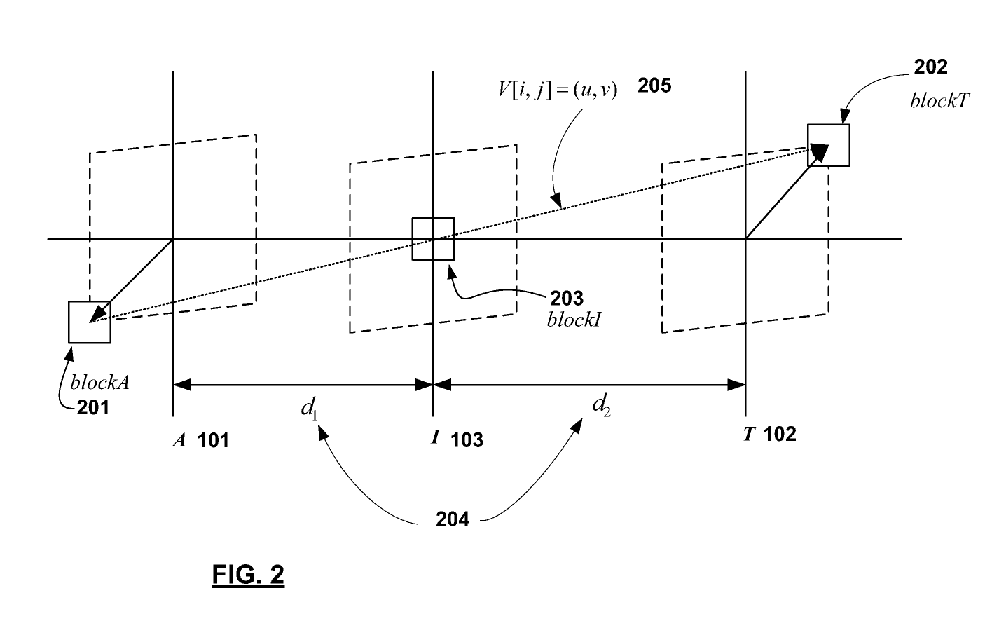

In accordance with the proposed solution, a block-wise FRC is employed wherein the intermediate frame is divided into blocks and each block is interpolated using information in the anchor frame A 101 and the target frame T 102, as illustrated in FIG. 2. To simplify the interpolation, only two consecutive frames are used to reconstruct the intermediated frame. Blocks blockA 201, blockT 202 and blockI 203, are defined in the anchor, target and interpolated frames respectively. In the following description the resolution of the frame is assumed to be hsize and vsize, horizontally and vertically and the block size is M. Each block is then indexed by (i, j) in a hsize/M×vsize/M matrix. Let V[i, j]=(u,v) represent a 2-D motion vector projecting blockA 201 from anchor frame A 101 to blockT 202 in target frame T 102. Then, the intensity (luminance) of blockI 203 in the interpolated frame can be a linear combination of blockA 201 and blockT 202. Assuming the coordinates of the up-left corner of the blockI are (dx, dy), pixels (m, n) ε M×M in blockI 203 would be given by

$$blockI [ m , n ] = {w}_{1} blockA [ m , n ] + {w}_{2} blockT [ m , n ] \\ where \\ blockA [ m , n ] = A [ dx - \frac{d 1}{d 1 + d 2} u + m , dy - \frac{d 1}{d1 + d2} v + n ] \\ blockT [ m , n ] = T [ dx + \frac{d2}{d 1 + d 2} u + m , dy + \frac{d 2}{d 1 + d 2} v + n ] \qquad ( 1 )$$

The interpolated frame I 103 can then be reconstructed as

I[dx+m,dy+n]=blockI[m, n] (2)

In equation (1), dx=i*M , dy=j*M, and d₁ and d₂ are (time) distance between the frames 103 and 101, and frames 103 and 102, respectively. The weighting factors w₁ and w₂ are inversely proportional to the d₁ and d₂. V 205 is the motion field whose (i, j)th element is (u, v).

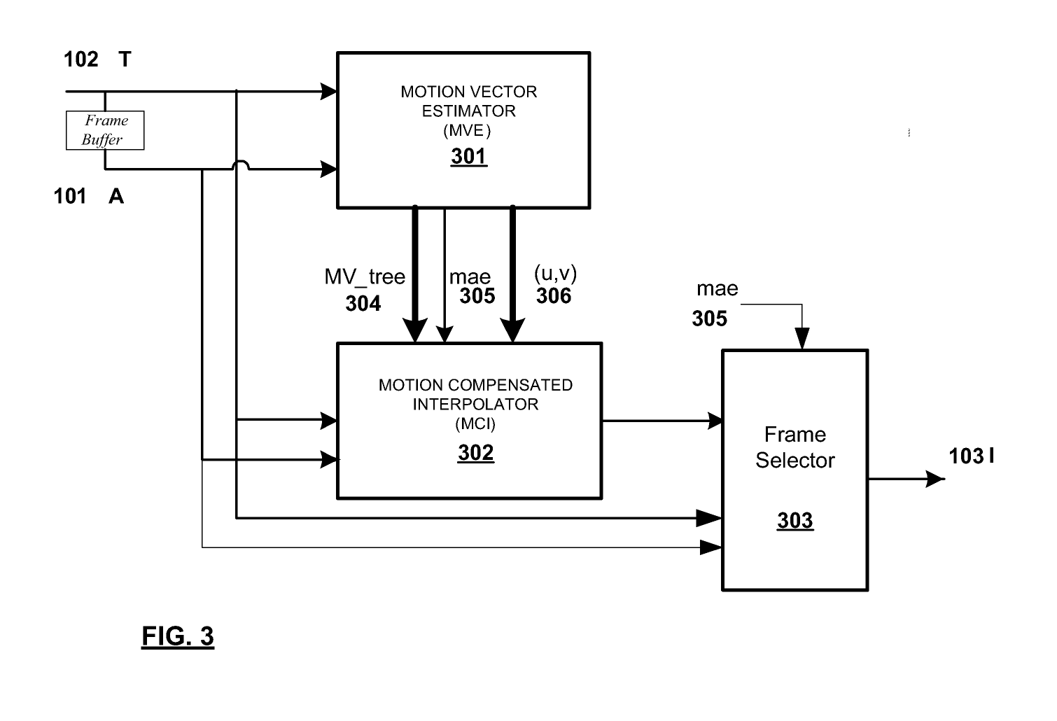

As illustrated in FIG. 3, applying the proposed FRC employs two important components. A Motion Vector Estimator (MVE) 301 which provides sub-block motion vectors of MV_tree 304, error mae₀ 305, and block motion vector (u, v) 306. The other component is a Motion Compensation Interpolator (MCI) 302 which reconstructs the intermediate frame with least block and/or halo artifacts. The MVE 301 and MCI 301 operate under the assumption that a certain similarity exists between frames 101 and 102. If the estimation error is too large (huge), which could be due to a scene change, another component the Frame Selector (FS) 303 is employed to output a copy of an original frame, the anchor frame 101 or the target frame 102 (to replace the interpolated frame 103) as the final output frame.

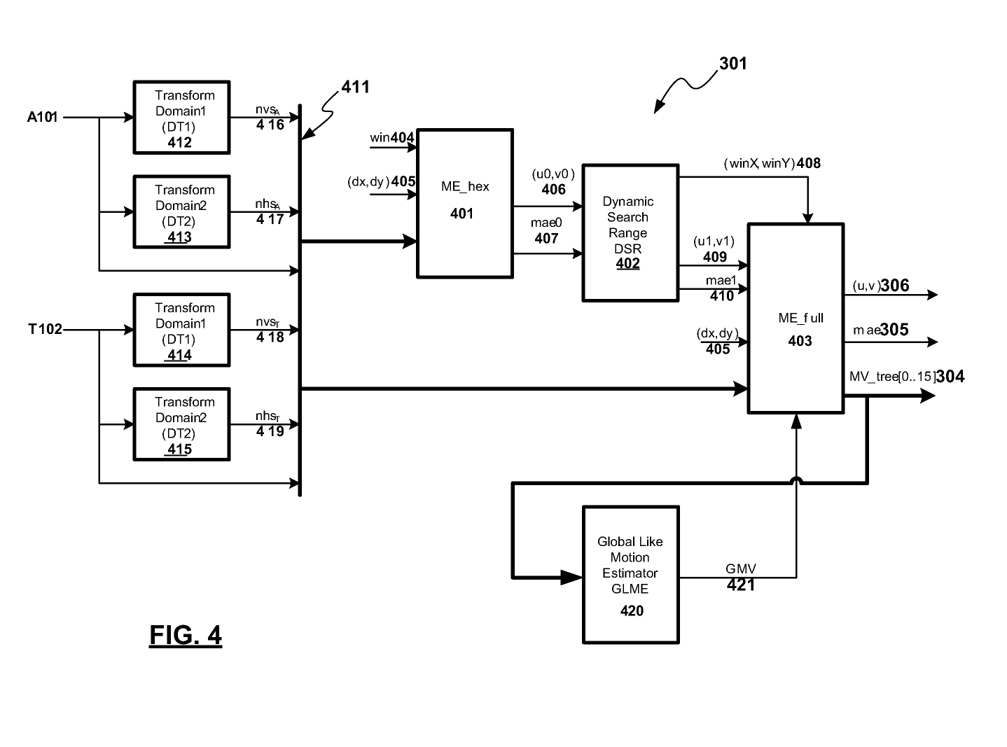

MVE 301 searches for a best match blockT 202 in the target frame T 102 for the blockA 201 in the anchor frame A 101. The MVE 301 meets many challenges such as low computation cost, dynamic performance including a wide range of motion vectors, the robustness of the motion vector that reflects the real moving projection. One embodiment of the MVE 301 is detailed in FIG. 4. The MVE 301 of FIG. 4 includes, in a first step, the construction of a bus signal 411 which is composed of the anchor image A 101, the target image T 102 and their respective transform images 416-417 and 418-419, transforms which are obtained from modules 412-413 and 414-415. The MVE 301 also includes, in a second step, four modules which receive and process the bus signal 411: the fast hexagonal search ME_Hex module 401, the Dynamic Search Range (DSR) module 402, the ME_Full module 403 and a fourth module, the Global-Like Motion Estimator (GLME) 420.

In accordance with an embodiment of the proposed solution, the domain transform modules 412-413 and 414-415 are employed to change the basis of the original image signal space to provide additional perspectives for the input frames A 101 and T 102. Various representations of the original signal permit, during the motion vector searching process, strengthening the robustness of a (determined) similarity measure between the anchor frame A 101 and the target frame T 102. The current embodiment is described with reference to two image transforms, however it should be understood that this number can vary. For simplicity however without losing the general objective, domain transform modules DT1 (412 or 413) and DT2 (414 or 415) employed are vertical and horizontal normalized Sobel operators, respectively. For example, on a pixel-(x,y) basis, signal 416 and 418 are calculated by using the following equation:

$${nvs}_{I} ( x , y ) = \frac{{S}_{vI} ( x , y )}{\sqrt{{S}_{vI}^{2} ( x , y ) + {S}_{hI}^{2} ( x , y )}}$$

and signals 417 and 419 are calculated by using the following equation:

$${nhs}_{I} ( x , y ) = \frac{{S}_{hI} ( x , y )}{\sqrt{{S}_{vI}^{2} ( x , y ) + {S}_{hI}^{2} ( x , y )}}$$

$$where \text{:}$$

$${S}_{vI} ( x , y ) = \frac{1}{8} [ ( I ( x - 1 , y - 1 ) - I ( x - 1 , y + 1 ) ) + 2 * ( I ( x , y - 1 ) - I ( x , y + 1 ) ) + ( I ( x + 1 , y - 1 ) - I ( x + 1 , y + 1 ) ) ]$$

$${S}_{hI} ( x , y ) = \frac{1}{8} [ ( I ( x - 1 , y - 1 ) - I ( x + 1 , y - 1 ) ) + 2 * ( I ( x - 1 , y ) - I ( x + 1 , y ) ) + ( I ( x - 1 , y + 1 ) - I ( x + 1 , y + 1 ) ) ]$$

and I is either the anchor frame A 101 or the target frame T 102.

With reference to FIG. 4, a preset win 404 input indicates the search window size while the ME_hex 401 and (dx,dy) 405 gives the position of currently processed block. The fast search ME_hex 401 provides an initial motion vector (u0,v0) 406 (estimate) and its corresponding estimation error mae0 407. From this initial (estimated) motion vector information, the DSR 402 then adjusts a search window size (winX, winY) 408 for the ME_full 403. Final motion vectors, including sub-block motion vectors of MV_tree 304, error mae 305, and block motion vector (u, v) 306 are searched for by the ME_full 403 and provided as outputs. The GLME 420 module uses the motion vectors found MV_tree 304, to determine the overall motion for the whole image. By compiling all the values of MV_Tree 304 calculated at each block (dx,dy) of the image, a statistic measure is provided from which the GLME 420 module establishes the most dominant motion vector which is used as an indication of overall image motion. For example, a histogram can be employed to provide the statistic measure. This dominant MV is then provided (output) as output 421 and used as the frame's global motion vector (GMV) during the next motion search for each new block, i.e. information regarding global motion (GM) is already available at the early motion search stages for the following frame. It is pointed out that the GMV is frame-based, determined from the current frame but used for the next frame. This is a valid approach since global motion does not change from one frame to another but rather stays stable during a period of time. Therefore, the GLME of the proposed solution is not only less greedy in terms of resources but is also more efficient.

For example, details of an implementation of components ME_hex 401, DSR 402 and ME_full 403 include:

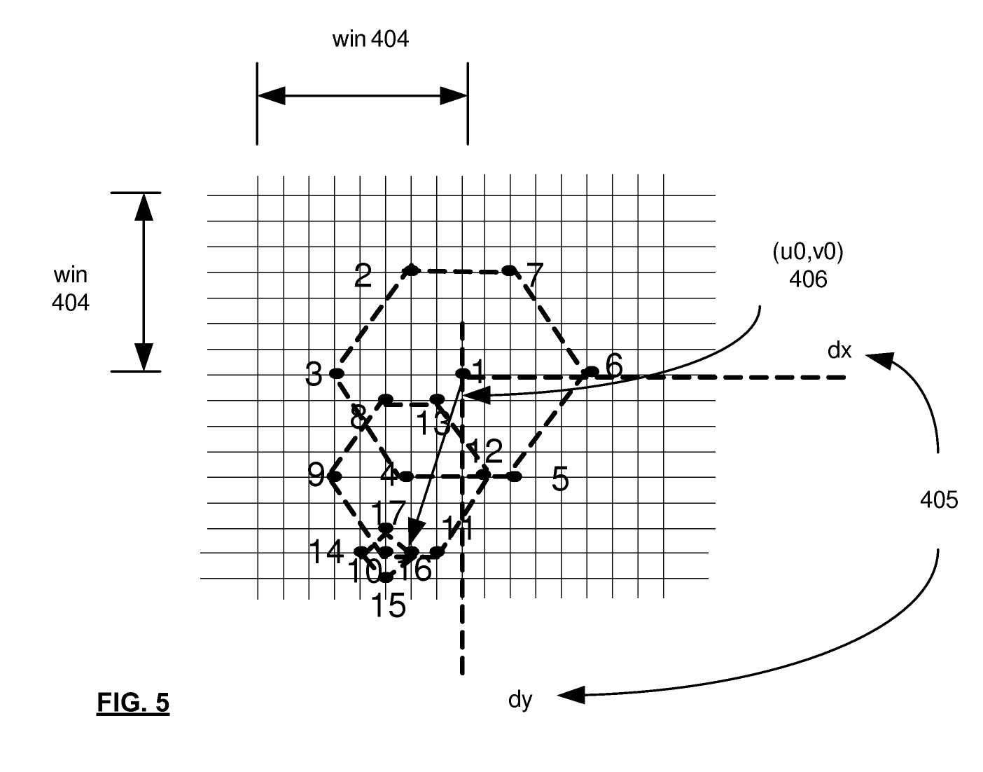

FIG. 5 illustrates ME_hex module 401. The ME_hex 401 module implements a fast search algorithm. In this step, a first initial motion vector is obtained by ME_hex 401 with lightweight computation employing a three-step fast search. For example at each step, the step size is shrunk by half. In accordance with the proposed solution, at each step six candidates are sampled in a hexagonal pattern. The invention is not limited to sampling six candidates in a hexagonal pattern, five or more candidates are employed instead of the four sample candidates defining a square shape in conventional searches. It has been discovered that the hexagonal shape is directionally more uniform than the square shape. In the search window, at each stage, six candidates are checked and their corresponding sum of absolute differences (SAD) are compared, for example:

$$S A {D}_{x , y} = {\sum }_{( m , n ) ∈ M \times M} \vert \begin{matrix}A [ dx + m , dy + n ] - \\ T [ dx + m + x , dy + n + y ]\end{matrix} \vert + \vert \begin{matrix}{nvs}_{A} [ dx + m , dy + n ] - \\ {nvs}_{T} [ dx + m + x , dy + n + y ]\end{matrix} \vert + \vert \begin{matrix}{nhs}_{A} [ dx + m , dy + n ] - \\ {nhs}_{T} [ dx + m + x , dy + n + y ]\end{matrix} \vert \qquad ( 3 )$$

where (x, y) is the coordinate shift of the candidate block. The best matched motion vector is the shifted (x, y) with the minimum SAD in the search window

$$( u 0 , v 0 ) = {arg}_{( x , y ) ∈ win} min ( {SAD}_{x , y} ) \qquad ( 4 )$$

A search example is illustrated in FIG. 5, including:

Step 1: Calculate the SAD of seven candidates of the current hexagonal region, where the candidates are located at the six corners of a hexagonal shape and at its center.

Step 2: If the candidate with smallest SAD is located at the corner, set it as the center of the next hexagonal region. Repeat step 1.

Step 3: If the best candidate is located at the center, turn to the inner search pattern. Calculate the four nearest candidate around the center.

Step 4: If the best candidate is located at the center or at the boundary of the search window, terminate and return the location of the best candidate.

Step 5: Store the position of the final best candidate as the initial motion vector (u0, v0) 406 and the corresponding SAD as the mae0 407.

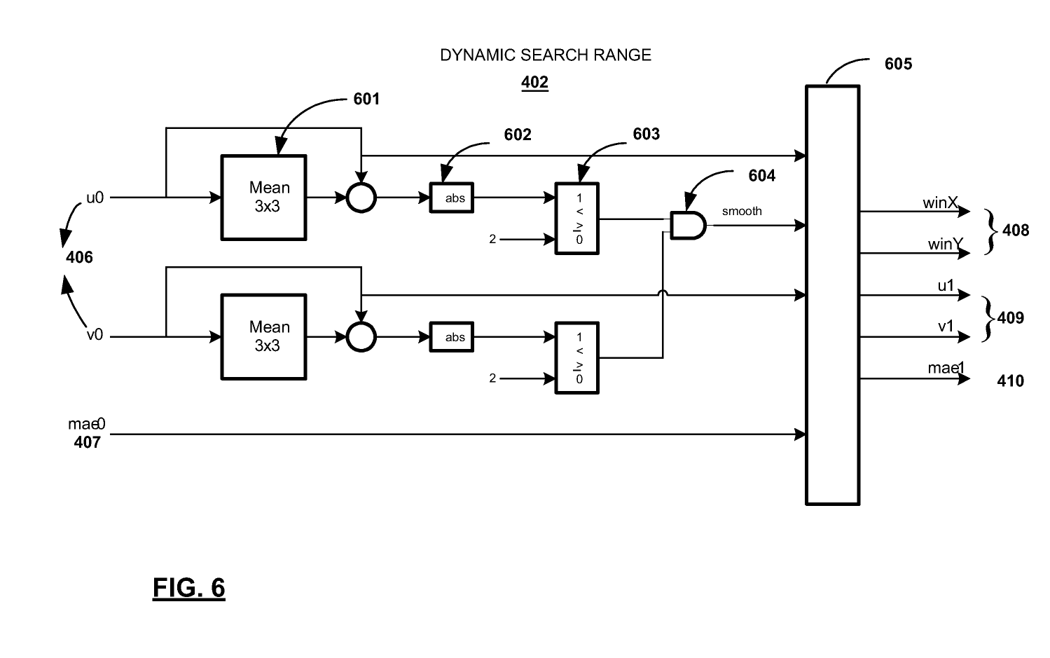

The initial motion estimate from ME_hex 401 marks out the search area for an exhaustive motion vector search. The DSR component 402 provides dynamic performance as well reduce computation cost. As shown in FIG. 6, DSR 402 takes the initial motion vectors (u0, v0) 406 and their corresponding estimation error mae0 407 from ME_hex 401 and provides the search window size (winX, winY) 408 for the next full search ME_full 403. Based on the smoothness of the motion vector field and the estimation error, the DSR 402 expands or shrinks the size of the search window size win 404 (FIG. 5). The smoothness of the motion field is determined by the difference between the current motion vector and its average within a neighborhood of the current motion vector. In the present illustration, the neighbor region is fixed to a 3×3 window and this measure of smoothness is realized by units 601-604. For a block 201 corresponding to a stable background, the estimation error mae0 407 is small and the motion field is smooth. Therefore, the search window can be shrunk, which significantly speeds up the heavy burden for the next full search as described below. On the other hand, for a frame block representing a fast moving object, the actual movement can require a motion vector which can exceed the limits of the pre-set search window. Since the fast search cannot find a good match for the fast moving object, the corresponding estimation error can be quite large. Dynamic performance is achieved by enlarging the search window size. Also, shrinking the search window size helps to avoid a possible mismatch and local minima traps. In accordance with the proposed embodiment, an example of an implementation of this strategy is shown in the search window determination unit 605.

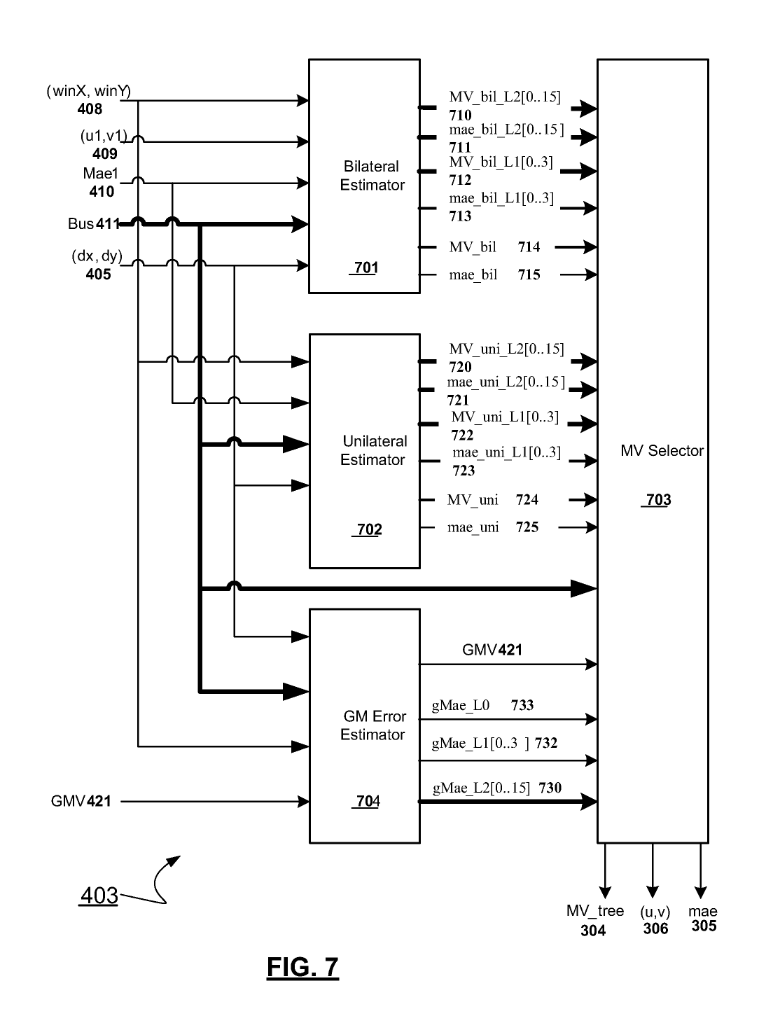

Unlike the ME_hex 401, the ME_full 403 undertakes an exhaustive motion vector search. An implementation of the ME_full is illustrated in FIG. 7, for example including Bilateral Estimator 701, Unilateral Estimator 702, and MV Selector 703. Since the robustness and quality of the motion vector is realized in the ME_full 403, which indicates the movement of objects in a scene, the output motion vector (u, v) 306 has a direct impact on the performance of the overall FRC. However, due to a number of reasons, such as occlusion and transformation of an object, the motion estimation cannot always provide the true movement. To provide a robust motion vector, overall three first-level block motion vector sets MV_bil 714, MV_uni 724 and GMV 726 are calculated, which is explained herein below. To refine the motion estimation, a three level block segmentation is employed, for example four second-level sub-blocks and sixteen third-level sub-blocks. All motion estimators share similar processing flow (engine/infrastructure), as detailed herein below. Accordingly, a final motion vector is chosen from all these motion vectors and giving as a final output sub-block motion vector set MV_tree 304, corresponding estimation error mae 305 and the block motion vector (u, v) 306. The selection strategy is explained herein below.

With reference to the above description, in order to improve robustness of the motion estimation, two motion projections are considered: unilateral projection and bilateral projection. For example, unilateral motion estimation projects the block from the anchor frame to the target frame with the matching criteria being:

$${SAD\_uni}_{x , y} = {\sum }_{m , n ∈ \frac{M}{4} \times \frac{M}{4}} \vert \begin{matrix}A [ dx + m , dy + n ] - \\ T [ dx + x + m , dy + n + y ]\end{matrix} \vert + \vert \begin{matrix}{nvs}_{A} [ dx + m , dy + n ] - \\ {nvs}_{T} [ dx + x + m , dy + n + y ]\end{matrix} \vert + \vert \begin{matrix}{nhs}_{A} [ dx + m , dy + n ] - \\ {nhs}_{T} [ dx + x + m , dy + n + y ]\end{matrix} \vert \qquad ( 5 )$$

For bilateral motion estimation blocks in the anchor frame and in the target frame are projected to an (middle) intermediary frame and the matching criteria being:

$${SAD\_bil}_{x , y} = {\sum }_{m , n ∈ \frac{M}{4} \times \frac{M}{4}} \vert \begin{matrix}A [ dx + m - x , dy + n - y ] - \\ T [ dx + x + m , dy + n + y ]\end{matrix} \vert + \vert \begin{matrix}{nvs}_{A} [ dx + m - x , dy + n - y ] - \\ {nvs}_{T} [ dx + x + m , dy + n + y ]\end{matrix} \vert + \vert \begin{matrix}{nhs}_{A} [ dx + m - x , dy + n - y ] - \\ {nhs}_{T} [ dx + x + m , dy + n + y ]\end{matrix} \vert \qquad ( 6 )$$

From equations (5) and (6), it can be noted that these two methods have just a slightly difference: in (5) only the block in the target frame is shifted while in (6) both blocks in the anchor and target frames are shifted. Generally speaking, for smooth movement, these two estimations give similar results. But for moving objects unilateral estimation (5) gives a good result for displacing the main body of the object while bilateral estimation (6) may sometimes break the integrity of the moving object and generate certain holes in the moving object. On the other hand, bilateral estimation provides a more accurate result at the edge or boundary of moving objects and avoids a doubling effect commonly seen with unilateral estimation results.

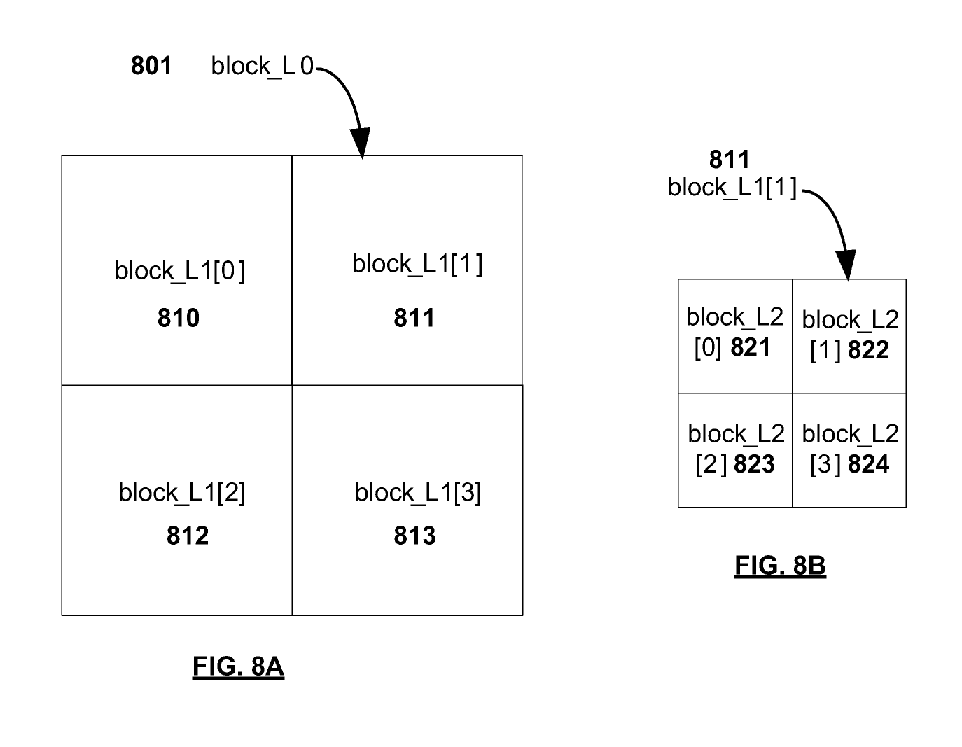

Further to the above description, to further enhance the accuracy of the motion estimation, a variable size block matching strategy is employed. The size of the block affects the performance of the motion estimation. Generally speaking, a big block with large size (in terms of pixels) would be more accurate in catching the movement of a moving object, while a small block with fewer pixels can be capable of grabbing details or smaller objects. In accordance with the proposed solution, a three level variable-size block matching is implemented in both unilateral and bilateral estimators 701 and 702. With reference to FIG. 8, an M×M block block_L0 801 is divided into four M/2×M/2 sub-blocks block_L1[0 . . . 3] 810-813, each of which is further divided into four M/4×M/4 sub-blocks, for a total of sixteen M/4×M/4 sub-blocks block_L2[0 . . . 15] 821-824.

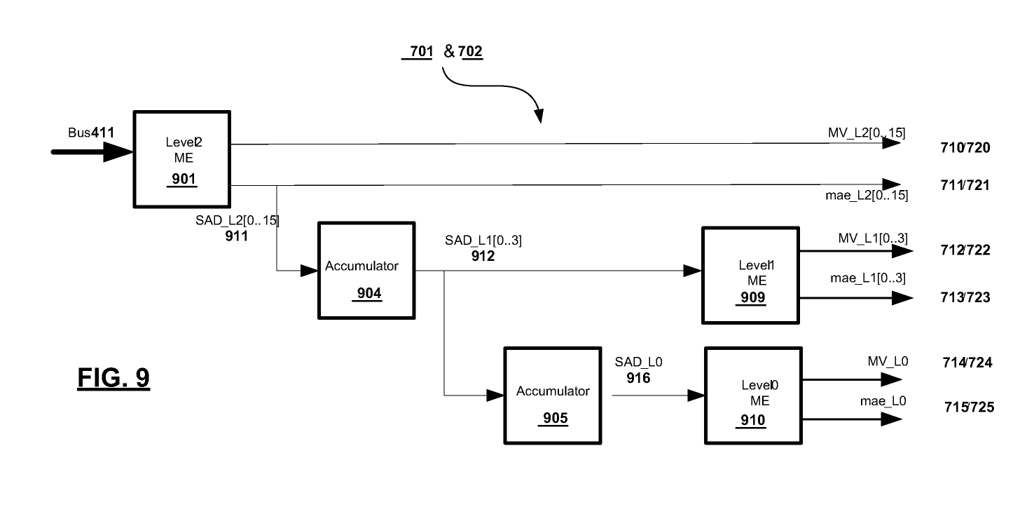

In accordance with an implementation of the embodiment, the three-level motion estimation for both unilateral estimator and bilateral estimator share the same processing flow illustrated in FIG. 9. At the third level, the search engine Level2 ME 901 calculates the SAD for sixteen M/4×M/4 sub-blocks located in the anchor frame and target frame, denoted as SAD_L2[0 . . . 15] 911. The shifted positions with minimum SAD are stored and output as the motion vectors MV_L2[0 . . . 15] 710 and 720, for bilateral and unilateral estimators, respectively.

Every four third level SAD_L2[0 . . . 15] 911 values are accumulated to form the second level SAD_L1[0 . . . 3] 912 values.

Level1 ME 909 compares and selects the motion vector with minimum SAD_L1 as the second level motion vectors MV_L1[0 . . . 3] 712 and 722, for bilateral and unilateral estimator, respectively.

Every four second level SAD_L1[0 . . . 3] 912 values are accumulated to form value SAD_L0 916. From this SAD_L0 value, Level0 ME 910 selects first level motion vectors MV_bil 714 and MV_uni 724, for bilateral and unilateral estimator respectively.

Beside the Unilateral and the Bilateral motion estimators (ME), a Global Motion Error Estimator computes the error for the block relative to the GMV 421. The error calculation (calculus) is realized the same way as for the (first two) unilateral and bilateral MEs, with the exception that no displacement shift is employed to search for the minimum error since the MV is (are) known from GMV 421. For example, the error corresponding to the GMV 421 is calculated according to:

$${SAD}_{GMxy} = {\sum }_{m , n ∈ \frac{M}{4} \times \frac{M}{4}} \vert \begin{matrix}A [ dx + m , dy + n ] - \\ T [ dx + {GMV}_{X} + m , dy + {GMV}_{Y} + y ]\end{matrix} \vert + \vert \begin{matrix}{nvs}_{A} [ dx + m , dy + n ] - \\ {nvs}_{T} [ dx + {GMV}_{X} + m , dy + {GMV}_{Y} + y ]\end{matrix} \vert + \vert \begin{matrix}{nhs}_{A} [ dx + m , dy + n ] - \\ {nhs}_{T} [ dx + {GMV}_{X} + m , dy + {GMV}_{Y} + y ]\end{matrix} \vert \qquad ( 7 )$$

where (GMVₓ, GMV_{y})=GMV. The three-level error estimation (the motion vector being the same for all levels) is computed as previously described hereinabove, and the errors gMae 730, gMae_L1[0 . . . 3] 732 and gMae_L2[0 . . . 15] 733, associated to GMV 421, are delivered as inputs to the MVS 703.

Overall, the ME_full 403 generates three first-level block motion vectors GMV 421, MV_bil 714 and MV_uni 724, two sets of four second-level sub-block motion vectors MV_bil_L1[0 . . . 3]/MV_uni_L1[0 . . . 3] 712/722 and two sets of sixteen third-level sub-block motion vectors MV_bil_L2[0 . . . 15]/MV_uni_L2[0 . . . 15] 710/720, as well as their corresponding estimation errors gMae 733, mae_bil 715, mae_uni 725, gMae_L1[0 . . . 3] 732, mae_bil_L1[0 . . . 3]/mae_uni_L1[0 . . . 3] 713/723, gMae_L2[0 . . . 15] 730, mae_bil_L2[0 . . . 15]/mae_uni_L2[0 . . . 15] 711/721. The overall processing flow of the sub-block motion estimation is illustrated in FIG. 9. It is noted that diagram FIG. 9 works for both bilateral and unilateral estimators. Therefore this processing flow is reusable with only a slight change in the calculation of SAD as (5) and (6).

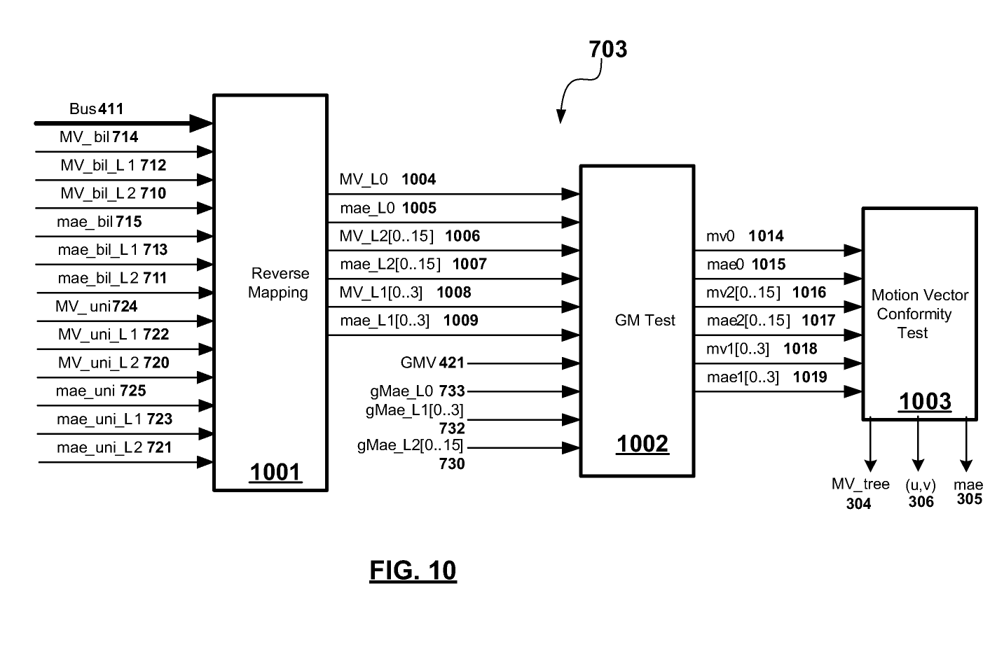

Accordingly, based on the motion vectors provided a MV Selector (MVS) 703 is employed to provide final motion vector (u, v) 306 and (uniform) sub-block motion vectors MV_tree 304 as the output. In accordance with the proposed solution, an implementation of motion vector selector 703 employs Reverse Mapping (RM) 1001, the Global Motion Test (GMT) 1002 and Motion Vector Conformity Test (MVCT) 1003 for example illustrated in FIG. 10.

The RM 1001 is used to select between bilateral and unilateral motion estimation. RM 1001 selects three level motion vectors (u, v) 306, MV_L1[0 . . . 3] 1108 and MV_L2[0 . . . 15] 1106 between the two sets of motion vectors provided by unilateral and bilateral estimations. In RM 1001, instead of displacing blocks into the target frame, blocks are moved into the anchor frame in a reverse direction provided by the motion vector(s). For example:

$$( u , v ) = {arg}_{MV\_bil , MV\_uni} min \{ \begin{matrix}{\sum }_{( m , n ) ∈ M \times M} \vert \begin{matrix}A [ ( dx + m , dy + n ) - MV\_bil ] - \\ T [ dx + m , dy + n ]\end{matrix} \vert + \\ \vert \begin{matrix}{nvs}_{A} [ ( dx + m , dy + n ) - MV\_bil ] - \\ {nvs}_{T} [ dx + m , dy + n ]\end{matrix} \vert + \\ \vert \begin{matrix}{nhs}_{A} [ ( dx + m , dy + n ] - MV\_bil ] - \\ {nvs}_{T} [ dx + m , dy + n ]\end{matrix} \vert , \\ {\sum }_{( m , n ) ∈ M \times M} \vert \begin{matrix}A [ ( dx + m , dy + n ) - MV\_uni ] - \\ T [ dx + m , dy + n ]\end{matrix} \vert + \\ \vert \begin{matrix}{nvs}_{A} [ ( dx + m , dy + n ) - MV\_uni ] - \\ {nvs}_{T} [ dx + m , dy + n ]\end{matrix} \vert + \\ \vert \begin{matrix}{nhs}_{A} [ ( dx + m , dy + n ) - MV\_uni ] - \\ {nhs}_{T} [ dx + m , dy + n ]\end{matrix} \vert\end{matrix} \} \qquad ( 8 )$$

The winner between MV_bil and MV_uni becomes the final output motion vector (u, v) 306 and is stored as V[i, j] 205. Once the bilateral and unilateral motion estimation is selected for the first level motion vector, the rest of two levels, MV_bil_L1[0 . . . 3]/MV_uni_L1[0 . . . 3] 712/722 and MV_bil_L2[0 . . . 15]/MV_uni_L2[0 . . . 15]710/720, are determined correspondingly, and only one set of motion vectors are output MV_L0 1004, MV_L1[0 . . . 3] 1008 and MV_L2[0 . . . 15] 1006.

The successful set of motion vectors MV_L0 1004, MV_L1[0 . . . 3] 1008 and MV_L2[0 . . . 15] 1006 (along with their respective errors) undergo a first test which is the GMT 1002. This test aims to compare, at each level, the corresponding error mae_Lᵢ(i=0, 1 and 2) versus their counterpart the global motion error gMae_Lᵢ. Whenever the similarity between mae_Lᵢ and gMae_Lᵢ is high, the motion vector for the sub-block (or block) at this level i is considered to be the global motion vector one, i.e. GMV 421. Otherwise, the sub-block (or block) at this level i is not moving following a global trend, but rather is characterized by a local movement and thus, will keep its initial motion vector detected MV_Lᵢ.

For the three-level variable block-size matching, since the motion vectors for each level is estimated independently, their motion projection may not be quite consistent. A MVC 1003 is employed to provide “uniform” motion vectors for the three level variable-size block matching. Conformity is implemented by comparing the motion vectors and the estimation error from the upper level to the lower-level. If the difference between the motion vectors is too big or the gain of the estimation error from the lower level is not big enough, the estimation error and the motion vectors from the lower-level is reset to the values of its upper-level. The conformed sixteen third-level sub-blocks motion vectors MV_L2[0 . . . 15] 1006 would be the final output motion vectors MV_tree 304.

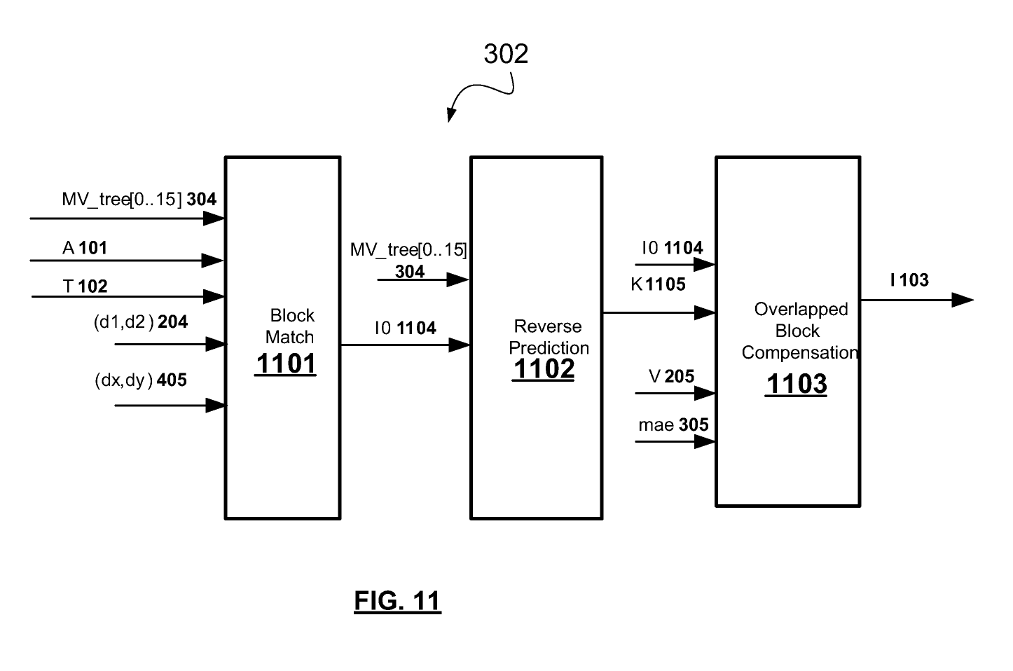

With the motion vector set, according to the equation (1) and (2), the interpolated frame I 103 can be reconstructed. In addition to the robustness of the MVE 301, the interpolation result can be reinforced through a technique called overlapped block compensation. Three components employed by Motion Compensation Interpolation (MCI) 302 are illustrated in FIG. 11. The Block Match (BM) 1101 component first employs the motion vector MV_tree 304 to reconstruct the initial interpolated frame I0 1104. The reconstruction process for example employs (1) and (2), except that blockI 203 is now composed of 16 M/4×M/4 sub-blocks. Suspect pixels are marked by Reverse Predication (RP) 1102 and stored in frame mask K 1105. These pixels will be replaced by the pixels with smoother visual performance generated from the Overlapped Block Compensation (OBC) 1103. The details of RP 1102 and the OBC 1103 include:

Using motion vectors provided by motion estimation, an initial interpolated frame I0 1104 is generated. Due to the limitations of the blocks the quality of the interpolated frame is not as good as that of the original frames. To further improve the sharpness of the image, artifacts associated with deformation of objects, occlusion of objects and illumination changes are found and corrected. Unlike all the previous components, which operate at the block level, finding and marking suspected artifacts are pixel-based. Marking suspect pixels is executed in RP 1102. The processing performed by RP 1102 is similar to that of RM 1002, where the initial interpolated frame I0 1104 is reverse projected and compared to the anchor and target frames, A 101 and T 102, respectively. For example:

$$\begin{matrix}diff\_A = abs ( \begin{matrix}I 0 [ ( dx + m , dy + n ) + \frac{d 1}{d 1 + d 2} MV\_tree ] - \\ A [ dx + m , dy + n ]\end{matrix} ) & ( 9 a ) \\ diff\_T = abs ( \begin{matrix}( I 0 [ dx + m , dy + n ) - \frac{d 2}{d 1 + d 2} MV\_tree ] - \\ T [ dx + m , dy + n ]\end{matrix} ) & ( 9 b )\end{matrix}$$

In equation (9a), the absolute value of the corresponding pixels in the initial interpolated frame I0 1104 and anchor frame A 101 is compared to a preset threshold Th 1106. If the difference is larger than the preset threshold, the corresponding pixel is then marked and stored in the mask frame K 1105. For example:

$$K [ dx + m , dy + n ] = \{ \begin{matrix}1 , & either diff\_A > Th or diff\_T > Th \\ 0 , & otherwise\end{matrix} \qquad ( 10 )$$

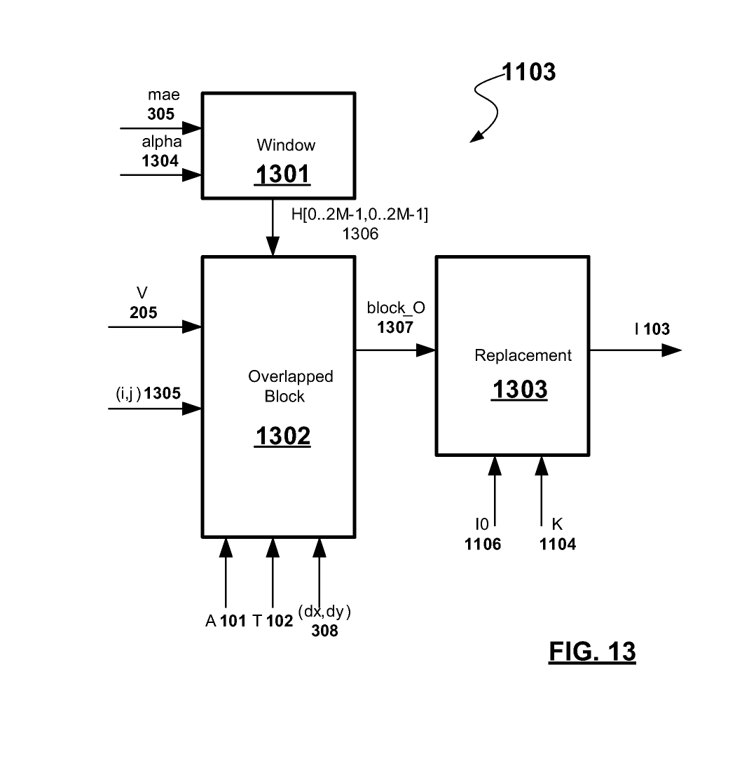

FIG. 12 illustrates an example of the mask frame K 1105. In this way, a pixel-wise mask map is obtained. The generated mask frame is then post-processed by an erosion operator to remove isolated and spike points in the mask and provides a smooth mask with natural shape. The smoothing procedure employs a 3-by-3 (pixel) window around each current marked pixel. If the number of marked pixels in the window is small, the mark on the current pixel is removed. The pixel-wise mask frame K 1105 helps treat only those necessary pixels and keep the good ones intact. In this way, the sharpness of the image is further improved.

With all the suspect pixels being marked, an approach called overlapped block compensation (OBC) is used to reduce the uncomfortable visual impact. Instead of resorting to a complicated algorithm to solve these problems, a post-processing method with light computation is used to address them. OBC 1103 borrows information from neighbor blocks to filter out a number of distortions. Instead of using only the pixels inside the center block, the pixels considered by OBC 1103 include the combination of the eight surrounding regions plus the center block. A weight of the combination is determined by a 2-D window. The details of the combination and the overlapped window are explained below.

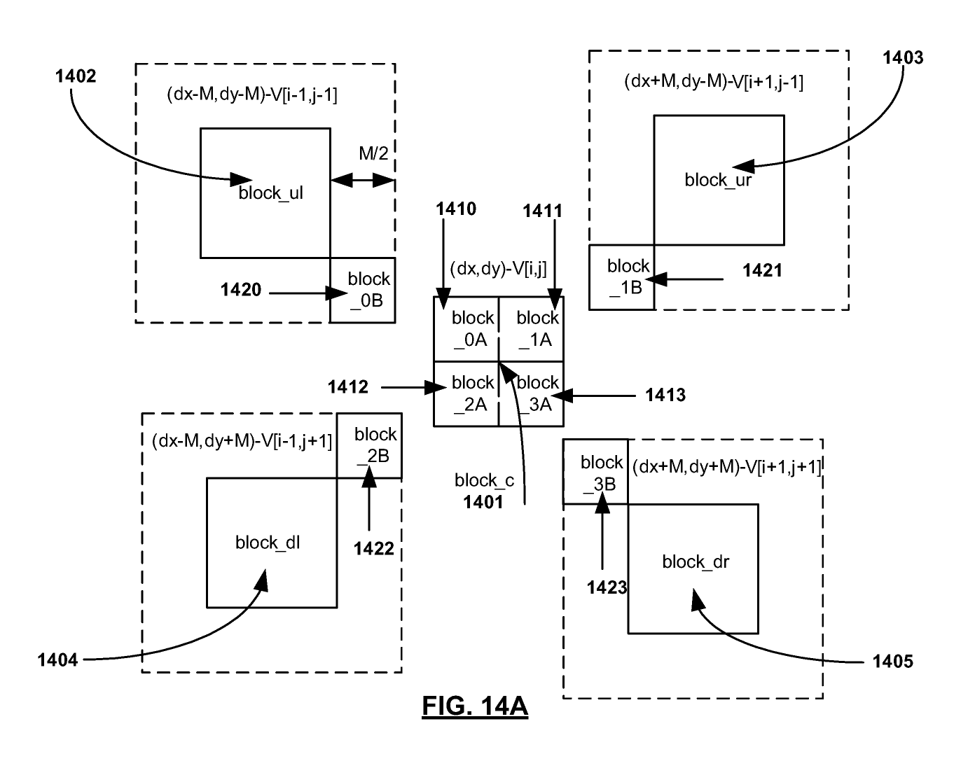

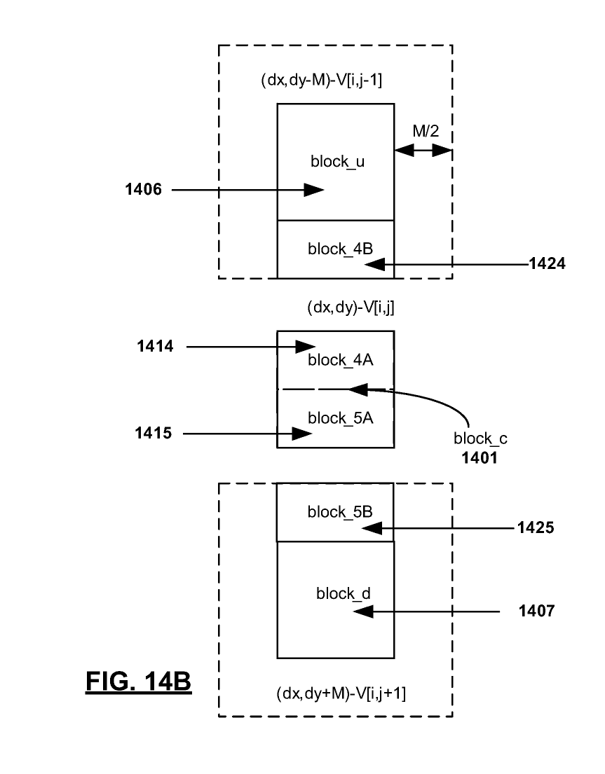

For example, an implementation of the OBC 1103 is illustrated in FIG. 13, where the Overlapped Block unit 1302 generates the block_O 1307 whose pixels are a linear combination of nine adjacent blocks with the overlapped window H 1306 generated by Window unit 1301. According to the mask frame K 1104, the Replacement unit 1303 replaces the pixels of the initial interpolated frame I0 1106 by the corresponding pixels from block_O 1307. In the OBC, the center block block_c 1401 is surrounded by 8 blocks, block_ul, block_ur, block_dl, block_dr, block_u, block_d, block_I and block_r, 1402-1409, as illustrated in FIG. 14(a)-(c). With each block extended by two times (i.e. each block has an overscan region around it extending the block to two times its size), the up-left, up, up-right, left, center, right, down-left, down, down-right blocks overlap with the center block. From FIG. 14(a), it can be seen that for the four corner neighbor blocks block_ul, block_ur, block_dl and block_dr 1402-1405, the overlapped regions for each neighbor block is a M/2×M/2 block, block_0B-block_3B, 1420-1423, corresponding to the counterpart block_0A-block_3A, 1410-1413 in the center block block_c 1401. For the two vertical neighbor blocks block_u and block_d, 1406-1407 in FIG. 14(b), the overlapped regions is a M×M/2 block, block_4B-block_5B, 1424-1425, corresponding to the counterpart block_4A-block_5A, 1414-1415 in the center block. For the two horizontal neighbor blocks block_I and block_r, 1408-1409 in FIG. 14(c), the overlapped region is a M/2×M block, block_6B-block_7B, 1426-1427, corresponding to the counterparts block_6A-block_7A, 1416-1417 in the center block. The pixels of the overlapped block block_O 1307 are contributed by all of these corresponding overlapped regions.

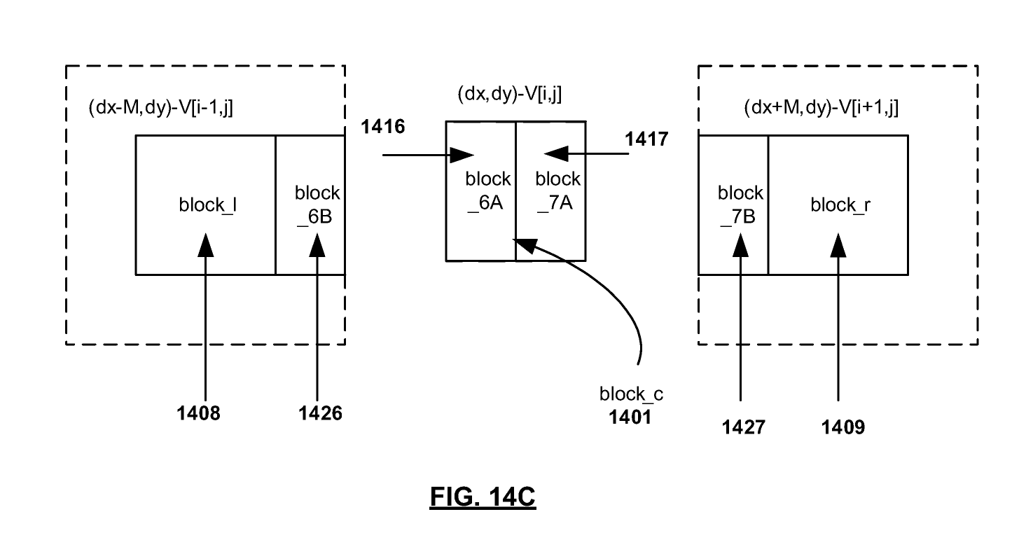

In accordance with the proposed solution, a weighting window is employed to linearly combine these regions. In accordance with an embodiment of the proposed solution, the window function is configured to give more weight at the center and gradually diminish close to zero towards the (far end) edges, for example a Kaiser-Bessel derived (KBD) window. The general shape of the window can look like that illustrated in FIG. 15. The overlapped window H 1306 is generated by Window unit 1301, whose shape is controlled by the factor α 1304. The KBD window function can be defined in terms of the Kaiser window (wₙ) for example by:

$${h}_{α} [ n ] = \{ \begin{matrix}\sqrt{\frac{{\sum }_{j = 0}^{n} {w}_{α} [ j ]}{{\sum }_{j = 0}^{M} {w}_{α} [ j ]}} & 0 \leq n < M \\ \sqrt{\frac{{\sum }_{j = 0}^{2 M - 1 - n} {w}_{α} [ j ]}{{\sum }_{j = 0}^{M} {w}_{α} [ j ]}} & M \leq n < 2 M\end{matrix} \\ where \\ {w}_{α} [ n ] = \{ \begin{matrix}\frac{{I}_{0} ( α \sqrt{1 - {( \frac{2 n}{M} - 1 )}^{2}} )}{{I}_{0} ( α )} & 0 \leq n \leq M \\ 0 & otherwise\end{matrix} \qquad ( 11 )$$

In (11), the Kaiser window wₙ is based on a Bessel function I₀(x) given by

$$\begin{matrix}{I}_{0} ( x ) = {\sum }_{m = 0}^{∞} \frac{{( - 1 )}^{m}}{m ! Γ ( m + α + 1 )} {( \frac{x}{2} )}^{2 m + α} & ( 12 ) \\ Γ ( z ) = \frac{1}{z} {\prod }_{n = 1}^{∞} \frac{{( 1 + \frac{1}{n} )}^{z}}{1 + \frac{z}{n}} & ( 13 )\end{matrix}$$

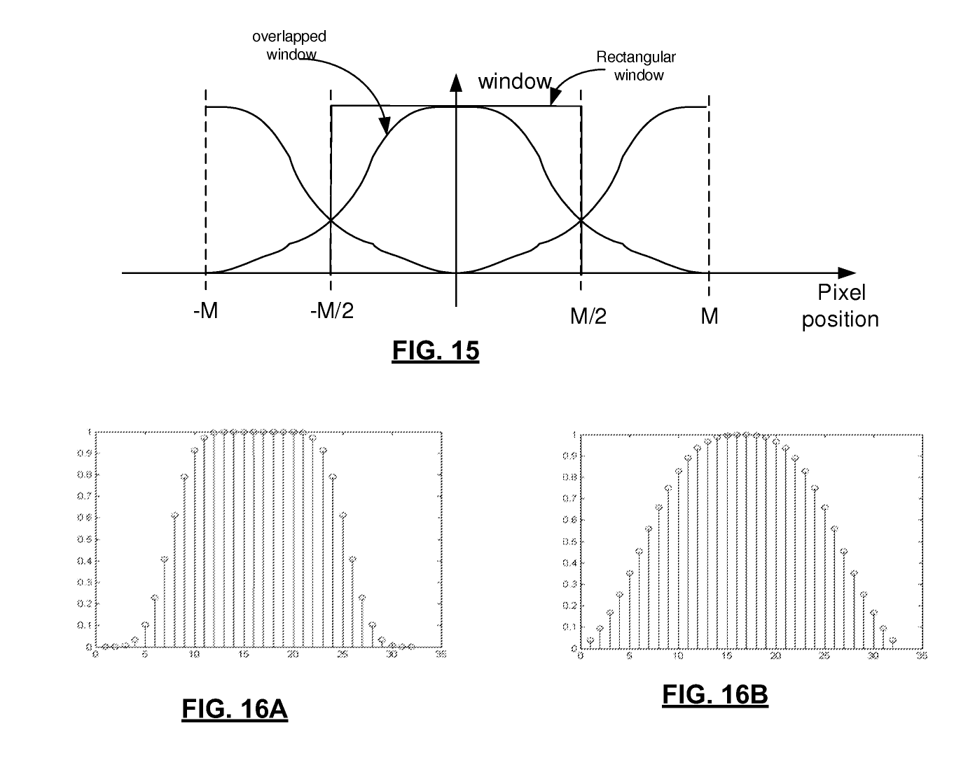

In (12) and (13), the Bessel function I₀(x) and Gamma function Γ(x) is expressed in Taylor form (expression) so that it can be approximated by the first (order) fewer items. A KBD window of length 32 with different α is shown in FIG. 16. The parameter α can be chosen to adjust the shape of the overlapped window. For example, in FIG. 16(a) the parameter α is set to 8 and in FIG. 16(b) is set to 2. It is noted that large α results in increased (more) fidelity (value) at the center of the block. When α tends to infinity (large), the overlapped window turns into a rectangular window, which does not incorporate neighboring information at all. By adjusting parameter α, blocks with strong block artifacts can be heavily blurred and/or the sharpness of blocks can be kept with slight block artifacts.

It is noted that the KBD window has the following properties:

h²[n]+h²[N−n]=1 (14)

h[n]=h[N−n] (15)

Property (14) guarantees the sum of overlapped window to be unity and (15) describes symmetry about the center of the window/block. Property (14) guarantees that a smooth picture with uniform intensity passed to the overlapped window, the output picture is as same as the original input.

With the (weighting) value of window close to one in the center which decays to zero at the edge, this Bessel window substantially meets the requirement for the overlapped window. Parameter α 1304 can be chosen to adjust the shape of the overlapped window. By adjusting this parameter, the blocks with big estimation error mae 305 can be heavily blurred while at the same time the sharpness of the block with small estimation error can be kept.

With the overlapped window and the neighborhood blocks, the overlapped block block_O 1307 can be rebuilt, noticing that the corresponding motion vectors for each block are given by V[i−1 . . . i+1,j−1 . . . j+1]. Each block is then modulated by the overlapped window and pixels in the dark region weighted by the corresponding coefficients of the window.

For example, for the up-left corner of the block_O, the pixel value is given by

block_{—}O[m, n]=block_{—}1A[m, n]·h[m+M/2, n+M/2]+block_{—}1B·h[m+3M/2, n+3M/2]+block_{—}2B ·h[m+M/2,n+3M/2]+block_{—}4B·h[m+3M/2,n+M/2] (16)

Then, in the Replacement unit 1303, the region in mask frame K[m,n] is checked, where [m,n]ε[dx . . . dx+M−1, dy . . . dy+M−1]. For all the location being marked, the corresponding pixel in the initial interpolated frame I0 1106 is replaced by the pixels in block_O 1307 and stored in the final output frame I 103.

In some embodiments, such as super-slow motion for sports, interpolating more than one frame between existing frames is performed. In our application, the computation-heavy motion projection is executed only once in MVE 301. With the same set of motion vector, multiple interpolated frames are generated from the MCI 302. The embodiments of the application only involve the general computation without any specific calculation and therefore can be implemented on any machine capable of processing image data. The block-based embodiment provides high modularity to the application, which is desirable for the parallel hardware implementation. Also, the embodiment makes a safe separation of the MVE 301 and MCI 302, which allows alternative algorithms for the search of the motion vector without departing from the scope of the embodiments given herein. As such, the present invention should not be limited only by the following claims.

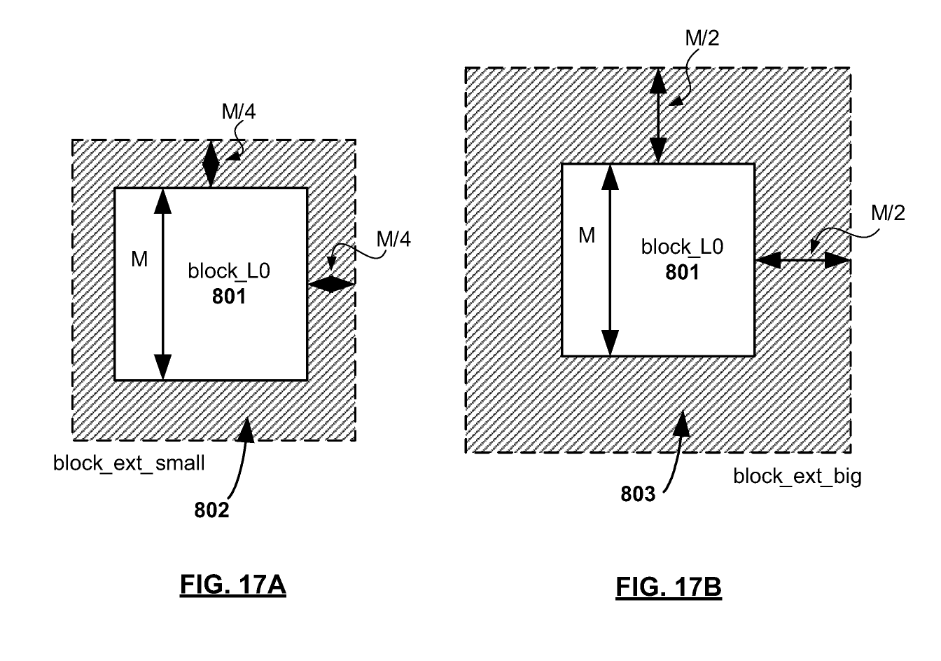

In accordance with a second embodiment of the proposed solution, the reverse mapping 1001 employed in selecting one of the unilateral motion estimation and the bilateral motion estimation can be replaced by a difference extending approach. To estimate the motion vector of a current block, one does not only calculate the SAD for the pixels inside the block, but the SAD of neighboring pixels is also taken into consideration in the search of the motion vector of the block. It has been discovered that extending the block (overscan) is a quite an efficient tool to address object occlusions. One of the parameters concerns the number of neighboring pixels to consider. Generally speaking, a “big block extending” technique provides a more robust motion vector for a block with big occlusions and a “small block extending” technique is more suitable for a solid object moving in a smooth background. In one implementation, two types of extending techniques are employed. As illustrated in FIG. 17, “big block extending” covers M/2 region as block_ext_big 803 around block block_L0 801, while “small block extending” just covers over M/4 region block_ext_small 802. Both unilateral estimator 701 and bilateral estimator 702 have two extending modules. Thus the overall motion vectors include four types, MV_bil_big , MV_bil_small, MV_uni_big and MV_uni_small.

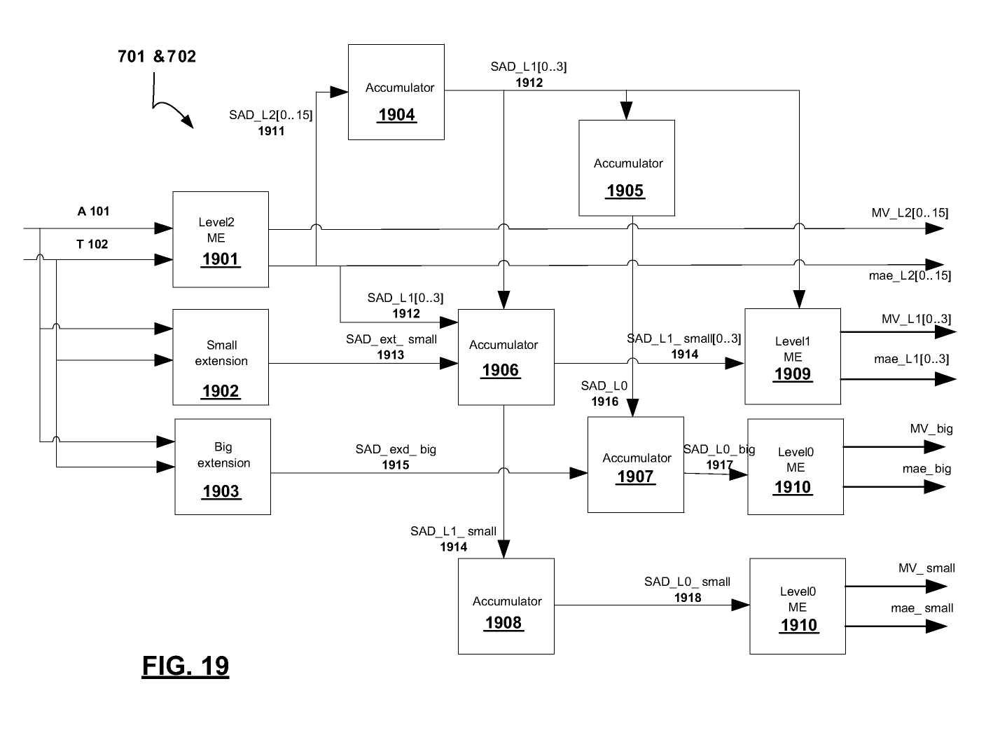

In accordance with the second embodiment of the proposed solution, the three-level motion estimation with two extending modes for both unilateral estimator and bilateral estimator share the same flow as shown in FIG. 19. In the third level, the search engine Level2 ME 1901 calculates the SAD for sixteen M/4×M/4 sub-blocks located the anchor frame and target frame, noted as SAD_L2[0 . . . 15] 1911. The shifted position with minimum SAD is stored and output as the motion vectors MV_L2[0 . . . 15] 710 or 720, for bilateral and unilateral estimators, respectively.

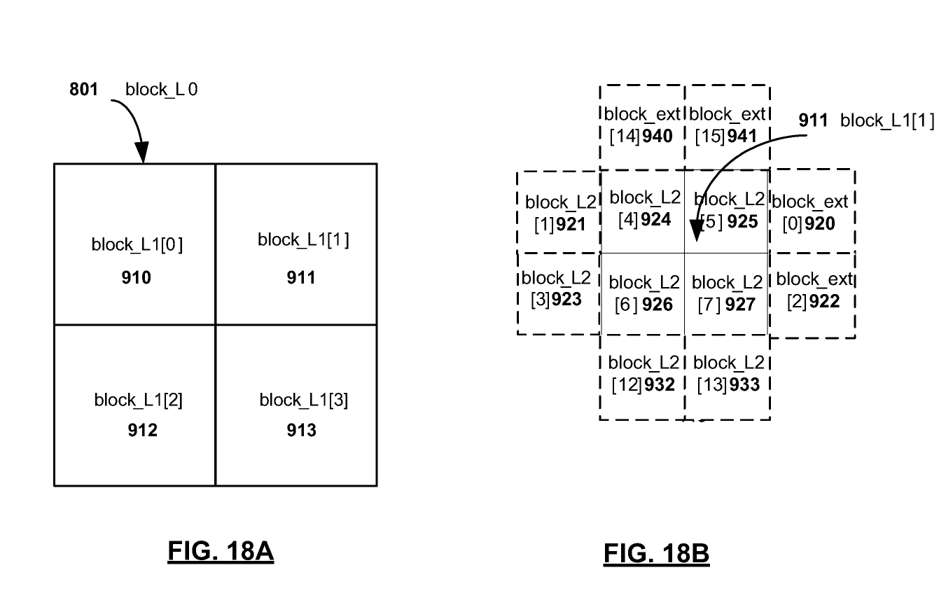

Every four third level SAD_L2[0 . . . 15] 1911 are accumulated and form second level SAD_L1[0 . . . 3] 1912. The SAD for the second level motion estimation is also extended. One of the second-level extending examples is demonstrated in FIG. 18,

SAD_{—}L1_small[1]=SAD_{—}L1[1]+SAD_{—}L2[1]+SAD_{—}L2[3]+SAD_{—}L2[12]+SAD_{—}L2[13]+SAD_ext_small[1] (17)

where SAD_ext_small[1] 1913 is contributed by SAD_L2[14], SAD_L2[15] from the up-neighbor and SAD_L2[0], SAD_L2[2] from the left-neighbor, stored in the Small Extension unit 1902. Level1 ME 1909 compares and selects the motion vector with minimum SAD_L1_small as the final second level motion vectors MV_L1[0 . . . 3] 712 and 722, for bilateral and unilateral estimators, respectively.

Every four second level SAD_L1[0 . . . 3] 1912 are accumulated to provide SAD_L0 1916. This SAD_L0 is summed by big extending SAD_ext_big 1915 stored in Big Extension unit 1903 to provide the SAD_L0_big 1917. From these SAD_L0_big, Level0 ME 1910 selects first level motion vector MV_bil_big 714 and MV_uni_big 724, for bilateral and unilateral estimators, respectively.

Every four second level SAD_L1_small 1914 are accumulated to give SAD_L0_small 1918. From these SAD_L0_small , Level0 ME 1910 selects first level motion vector MV_bil_small and MV_uni_small, for bilateral and unilateral estimators respectively.

Overall, the ME_full 403 generates four first-level block motion vectors MV_bil_big 714, MV_bil_small , MV_uni_big 724 and MV_uni_small , two sets of four second-level sub-block motion vectors MV_bil_L1[0 . . . 3]/MV_uni_L1[0 . . 3] 712/722 and two sets of sixteen third-level sub-block motion vectors MV_bil_L2[0 . . . 15]/MV_uni_L2[0 . . . 15] 710/720, as well as their corresponding estimation errors mae_bil_big , mae_bil_small, mae_uni_big, mae_uni_small, mae_bil_L1[0 . . . 3]/mae_uni_L1[0 . . . 3] 713/723 and mae_bil_L2[0 . . . 15]/mae_uni_L2[0 . . . 15] 711/721. The overall processing flow of the sub-block motion estimation is illustrated in FIG. 19. It is noted that the processing flow illustrated in FIG. 19 works for both bilateral and unilateral estimators. Therefore this processing flow is reusable with only a slight change in the calculation of SAD as (5) and (6).

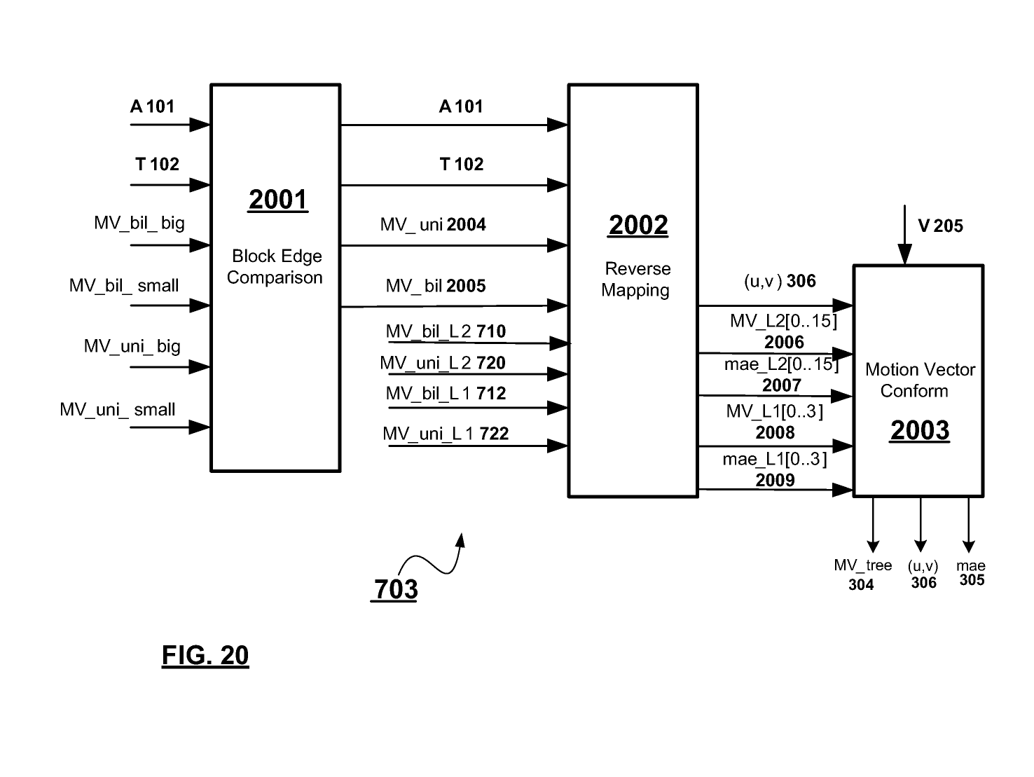

Based on the motion vectors provided, MV Selector (MVS) 703 is configured to provide the final motion vector (u, v) 306 and “uniform” sub-block motion vectors MV_tree 304 at the output. In accordance with an implementation, MVS 703 is includes three components, Block Edge Comparison (BEC) 2001, Reverse Mapping (RM) 2002 and Motion Vector Conform (MVC) 2003 illustrated in FIG. 20. The BEC 2001 is used to select between the big and small extending modes. The four motion vectors MV_bil_big, MV_bil_small, MV_uni_big and MV_uni_small are then reduced to two MV_bil 2005 and MV_uni 2004. RM 2002 then further selects the three level motion vectors (u, v) 306, MV_L1[0 . . . 3] 2008 and MV_L2[0 . . . 15] 2006 between the two sets of motion vectors with unilateral and bilateral estimation.

The BEC 2001 uses block boundary continuity to select between the big and small extending modes. For each block, it has up, left, right and down four adjacent blocks. For convenience of hardware implementation, only the up and left blocks can be considered to judge the smoothness of the block edge. With the motion vector

$$MV = \{ \begin{matrix}MV\_bil \_big , MV\_bil \_small , \\ MV\_uni \_big , MV\_uni \_small\end{matrix} \}$$

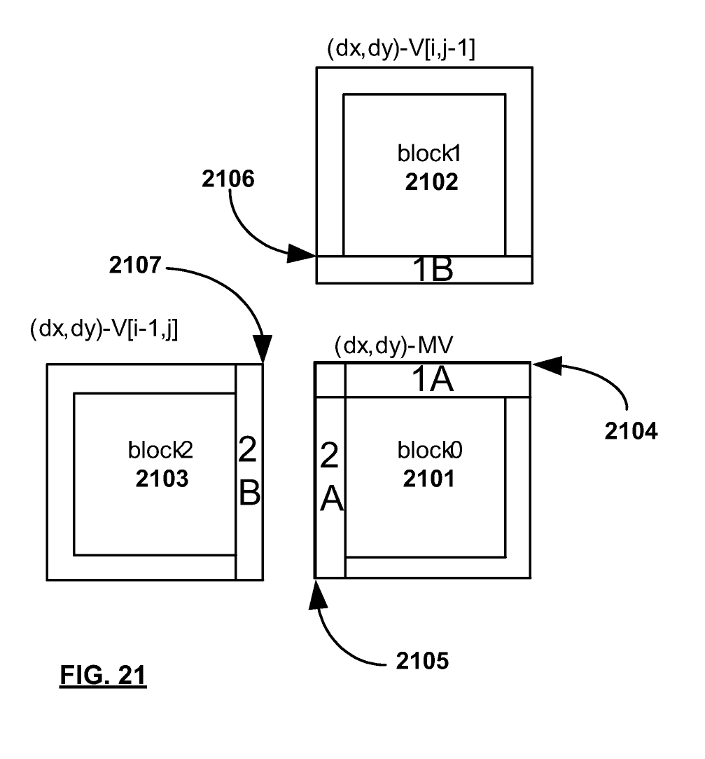

for the current block and V 205 for the past block, the shifted three neighbor blocks can be found, block0 2101, block1 2102 and block2 2103, as illustrated in FIG. 21, each with start position (dx, dy)−MV, (dx, dy)−V[i−1, j] and (dx, dy)−V[i, j−1]. The adjacent region 1A 2104 of block0 is compared to region 1B 2106 of up block1 2102 and region 2A 2105 of block0 2101 is compared to region 2B 2107 of left block2 2103. The motion vectors MV with the minimum difference for bilateral and unilateral modes will be stored as MV_bil 2005 and MV_uni 2004. After the selecting of BEC 2001, four motion vector candidates are reduced to two.

RM 2002 is employed to select between bilateral and unilateral motion estimation. In RM 2002, instead of displacing blocks into the target frame, the blocks are moved into the anchor frame in the reverse direction of the motion vector.

$$( u , v ) = {arg}_{MV\_bil , MV\_uni} min \{ \begin{matrix}{\sum }_{( m , n ) ∈ M \times M} abs ( \begin{matrix}A [ ( dx + m , dy + n ) - MV\_bil ] - \\ T [ dx + m , dy + n ]\end{matrix} ) , \\ {\sum }_{( m , n ) ∈ M \times M} abs ( \begin{matrix}A [ ( dx + m , dy + n ) - MV\_uni ] - \\ T [ dx + m , dy + n ]\end{matrix} )\end{matrix} \} \qquad ( 18 )$$

The winner of MV_bil and MV_uni becomes the final output motion vector (u, v) 306 and is stored as V[i, j] 205. Once the bilateral and unilateral motion estimation is selected for the first level motion vector, the rest of two levels, MV_bil_L1[0 . . . 3]/MV_uni_L1[0 . . . 3] 712/722 and MV_bil_L2[0 . . . 15]/MV_uni_L2[0 . . . 15] 710/720, are determined correspondingly, and only one set of motion vectors is output MV_L1[0 . . . 3] 2008 and MV_L2[0 . . . 15] 2006.

For three-level variable block-size matching, since the motion vectors for each level is estimated independently, their motion projection may not be quite consistent. To give uniform motion vectors for the three level variable-size block matching, a MVC 2003 is employed. Conformity is implemented by comparing the motion vectors and the estimation error from the upper level to the lower-level. If the difference of the motion vectors is too big or the gain of the estimation error from the lower level is not big enough, the estimation error and the motion vectors from the lower-level are reset to the values of the upper-level. The conformed sixteen third-level sub-blocks motion vectors MV_L2[0 . . . 15] 2006 is then the final output motion vectors MV_tree 304.

Accordingly there has been provided a method of interpolating images between a first anchor frame and a second adjacent target frames, the method comprising: estimating a block-based motion vector and corresponding variable-size sub-block motion vectors based on, and between the first anchor frame and a second adjacent target frames; and interpolating the digital image frame from the corresponding variable-size sub-block motion vector.

Additionally, estimating comprises: generating an initial motion vector using a fast three-step hexagonal pattern; dynamically setting the search window size for use with a full search pattern based on the initial motion vector; generating a final motion vector using the full search pattern, the final motion vector being indicative of the corresponding variable-size sub-block motion vector.

Further there has been provided an apparatus for interpolating a digital image frame located between a first anchor frame and a second adjacent target frame, the apparatus comprising: a motion vector estimator unit for estimating a block-based motion vector and a corresponding variable-size sub-block motion vector based on, and between the first anchor frame and the second adjacent target frame; and a motion compensation interpolation unit for interpolating the digital image frame from the corresponding variable-size sub-block motion vector.

We claim:

1. A method for generating a motion vector between an anchor frame and a target frame of an image stream, said method comprising:
defining a plurality of blocks at least in said anchor frame;
obtaining a coarse block-based motion vector estimate for each anchor frame block by comparing image information in each anchor frame block to image information in said target frame using in an overall pentagonal or higher pattern about a center position; and
obtaining at least one refined final motion vector by comparing image information in each said anchor frame block to image information in said target frame about said block-based motion vector estimate.

2. A method as claimed in claim 1, wherein said plurality of blocks comprises a plurality of first level blocks having a size, said method further comprising:
determining a degree of likeness between said image information providing an motion vector estimate error;
comparing said motion vector estimate error against an acceptable error threshold; and
if said motion vector estimate error is above said acceptable error threshold:
defining a plurality of sub-blocks within said first level block; and
obtaining a coarse block-based motion vector estimate for each sub-block by comparing image information in each anchor frame sub-block to image information in said target frame using an overall pentagonal or higher pattern.

3. A method as claimed in claim 1, wherein obtaining said coarse block-based motion vector estimate uses progressively variable step sizes having a diminishing progression.

4. A method as claimed in claim 3, wherein said variable steps diminish by half.

5. A method as claimed in claim 4 further comprising employing three steps providing improved convergence at reduced computational cost.

6. A method as claimed in claim 5, wherein said pattern employed at least in a first and a second step is pentagonal or higher providing a directional distribution of improved uniformity.

7. A method as claimed in claim 5, wherein said pattern employed at least in a second and a third step is quadragonal.

8. A method as claimed in claim 1, wherein said plurality of blocks comprises a plurality of first level blocks having a common size, obtaining said at least one final motion vector further comprises obtaining a motion vector set for variable-size sub-blocks within said first level block by comparing image information in each said sub-block to image information in said target frame about said block-based motion vector estimate.

9. A method as claimed in claim 1 further comprising generating at least one interpolated frame based on said at least one final motion vector for interpolating at least one image between said anchor frame and said target frame of said image stream having an initial frame rate.

10. A method as claimed in claim 9, said generating further comprising generating at least one temporal interpolated frame at an output frame rate different from said initial frame rate, said method providing frame rate conversion.

11. A method as claimed in claim 10, said output frame rate further comprising a lower frame rate compared to the initial frame rate providing frame rate down conversion.

12. A method as claimed in claim 10, said output frame rate further comprising a higher frame rate compared to the initial frame rate providing frame rate up conversion.

13. A method as claimed in claim 10, said method further comprising selecting said anchor image frame and said target image frame from said image stream about a frame time at said output frame rate.

14. A method as claimed in claim 9, said generating further comprising employing motion compensation for minimizing temporal interpolation artifacts.

15. A method as claimed in claim 9, wherein said anchor frame and said target frame comprise frames adjacent to at least one of a dropped frame, a missing frame and a degraded frame, said generating further comprising generating at said initial frame rate at least one temporal interpolated frame between said anchor and target frames, said method providing image stream restoration.

16. A method as claimed in claim 9 further comprising:
determining whether said anchor frame and said target frame correspond to a scene change; and
generating said interpolated frame including repeating one of said anchor frame and said target frame if said anchor frame and said target frame correspond to said scene change.

17. A method for generating a motion vector between an anchor frame and a target frame of an image stream, said method comprising:
defining a plurality of blocks at least in said anchor frame;
obtaining a coarse block-based motion vector estimate for each anchor frame block;
providing a search window based on the motion vector estimate; and
obtaining at least one refined final motion vector in a window having said corresponding search window size.

18. A method as claimed in claim 17 further comprising:
obtaining said coarse block-based motion vector estimate for each said anchor frame block by comparing image information in each anchor frame block to image information in said target frame using variable large step sizes in a pattern, a degree of likeness between said image information providing a motion vector estimate error;
defining said search window size based on said motion vector estimate error; and
obtaining said at least one fine final motion vector by comparing image information for each said anchor frame block to image information in said target frame in said window having said corresponding search window size about said block-based motion vector estimate.

19. A method as claimed in claim 18, providing said search window size further comprising providing a search window size varying inversely with said motion vector estimate error.

20. A method as claimed in claim 18, wherein obtaining said coarse block-based motion vector estimate uses progressively variable step sizes having a diminishing progression.

21. A method as claimed in claim 20, wherein said variable steps diminish by half.

22. A method as claimed in claim 21 further comprising employing three steps providing improved convergence at reduced computational cost.

23. A method as claimed in claim 22, wherein said pattern employed at least in a first and a second step is pentagonal or higher providing a directional distribution of improved uniformity.

24. A method as claimed in claim 22, wherein said pattern employed at least in a second and a third step is quadragonal.

25. A method as claimed in claim 18, wherein said plurality of blocks comprises a plurality of first level blocks having a common size, obtaining said at least one final motion vector further comprises obtaining a motion vector set for variable-size sub-blocks within said first level block by comparing image information in each said sub-block to image information in said target frame about said block-based motion vector estimate.

26. A method as claimed in claim 18 further comprising generating at least one interpolated frame based on said at least one final motion vector for interpolating at least one image between said anchor frame and said target frame of said image stream having an initial frame rate.

27. A method as claimed in claim 26, said generating further comprising generating at least one temporal interpolated frame at an output frame rate different from said initial frame rate, said method providing frame rate conversion.

28. A method as claimed in claim 27, said output frame rate further comprising a lower frame rate compared to the initial frame rate providing frame rate down conversion.

29. A method as claimed in claim 27, said output frame rate further comprising a higher frame rate compared to the initial frame rate providing frame rate up conversion.

30. A method as claimed in claim 27, said method further comprising selecting said anchor image frame and said target image frame from said image stream about a frame time at said output frame rate.

31. A method as claimed in claim 26, said generating further comprising employing motion compensation for minimizing temporal interpolation artifacts.

32. A method as claimed in claim 26, wherein said anchor frame and said target frame comprise frames adjacent to at least one of a dropped frame, a missing frame and a degraded frame, said generating further comprising generating at said initial frame rate at least one temporal interpolated frame between said anchor and target frames, said method providing image stream restoration.

33. A method as claimed in claim 26 further comprising:
determining whether said anchor frame and said target frame correspond to a scene change; and
generating said interpolated frame including repeating one of said anchor frame and said target frame if said anchor frame and said target frame correspond to said scene change.

34. A method for generating a motion vector between an anchor frame and a target frame of an image stream, said method comprising:
defining a plurality of blocks at least in said anchor frame; and
obtaining at least one motion vector by comparing image information in each said anchor frame block to image information in said target frame about a block-based motion vector estimate employing a plurality of motion estimators, each motion estimator having different properties under different conditions, each motion estimator providing a measure of motion estimation error, wherein one of said plurality of motion estimators is used based on a minimized motion estimation error to improve motion estimation reliability.

35. A method as claimed in claim 34 employing said plurality of motion estimators further comprises employing at least two of a unilateral motion estimator for estimating motion of blocks containing whole parts of moving objects in a scene, a bilateral motion estimator for estimating motion of blocks containing edges of moving objects in said scene and global motion estimator for estimating motion of blocks containing a background of said scene.

36. A method as claimed in claim 35 further comprising:
providing a motion vector estimate error based on a degree of likeness in comparing said image information in employing a corresponding motion estimator; and
hierarchically selecting one of said plurality of motion estimators for providing at least one final motion vector based on said motion vector estimate error.

37. A method as claimed in claim 36 said hierarchically selecting further comprising:
selecting one lateral motion estimator from said unilateral motion estimator and said bilateral motion estimator based on a reverse prediction; and
selecting one of said lateral motion estimator and said global motion estimator based on said final motion vector estimate errors provided by said lateral motion estimator and said global motion estimator.

38. A method as claimed in claim 34, wherein said plurality of blocks comprises a plurality of first level blocks having a common size, obtaining said at least one motion vector further comprises obtaining a motion vector set for variable-size sub-blocks within said first level block by comparing image information in each said sub-block to image information in said target frame about said block-based motion vector estimate.

39. A method as claimed in claim 34 further comprising generating at least one interpolated frame based on said at least one motion vector for interpolating at least one image between said anchor frame and said target frame of said image stream having an initial frame rate.

40. A method as claimed in claim 39, said generating further comprising generating at least one temporal interpolated frame at an output frame rate different from said initial frame rate, said method providing frame rate conversion.

41. A method as claimed in claim 40, said output frame rate further comprising a lower frame rate compared to the initial frame rate providing frame rate down conversion.

42. A method as claimed in claim 40, said output frame rate further comprising a higher frame rate compared to the initial frame rate providing frame rate up conversion.

43. A method as claimed in claim 40, said method further comprising selecting said anchor image frame and said target image frame from said image stream about a frame time at said output frame rate.

44. A method as claimed in claim 39, said generating further comprising employing motion compensation for minimizing temporal interpolation artifacts.

45. A method as claimed in claim 39, wherein said anchor frame and said target frame comprise frames adjacent to at least one of a dropped frame, a missing frame and a degraded frame, said generating further comprising generating at said initial frame rate at least one temporal interpolated frame between said anchor and target frames, said method providing image stream restoration.

46. A method as claimed in claim 34 further comprising:
determining whether said anchor frame and said target frame correspond to a scene change; and
generating said interpolated frame including repeating one of said anchor frame and said target frame if said anchor frame and said target frame correspond to said scene change.

47. A method for generating a motion vector between an anchor frame and a target frame of an image stream, said method comprising:
defining a plurality of blocks at least in said anchor frame; and
obtaining at least one block-based motion vector for each anchor frame block by comparing image information in each anchor frame block to image information in said target frame, said image information including image luminance and at least one image transform for identifying similarity measures between said anchor frame and said target frame.

48. A method as claimed in claim 47, said at least one image transform is generated by employing a normalized Sobel operator for changing the basis of an original image signal space.

49. A method as claimed in claim 48, generating said image transform further comprising one of a horizontal normalized Sobel operator and a vertical normalized Sobel operator.

50. A method as claimed in claim 47, wherein said plurality of blocks comprises a plurality of first level blocks having a common size, obtaining said at least one motion vector further comprises obtaining a motion vector set for variable-size sub-blocks within said first level block by comparing image information in each said sub-block to image information in said target frame.

51. A method as claimed in claim 47 further comprising generating at least one interpolated frame based on said at least one motion vector for interpolating at least one image between said anchor frame and said target frame of said image stream having an initial frame rate.

52. A method as claimed in claim 51, said generating further comprising generating at least one temporal interpolated frame at an output frame rate different from said initial frame rate, said method providing frame rate conversion.

53. A method as claimed in claim 52, said output frame rate further comprising a lower frame rate compared to the initial frame rate providing frame rate down conversion.

54. A method as claimed in claim 52, said output frame rate further comprising a higher frame rate compared to the initial frame rate providing frame rate up conversion.

55. A method as claimed in claim 52, said method further comprising selecting said anchor image frame and said target image frame from the image stream about a frame time at said output frame rate.

56. A method as claimed in claim 51, said generating further comprising employing motion compensation for minimizing temporal interpolation artifacts

57. A method as claimed in claim 47, wherein said anchor frame and said target frame comprise frames adjacent to at least one of a dropped frame, a missing frame and a degraded frame, said generating further comprising generating at said initial frame rate at least one temporal interpolated frame between said anchor and target frames, said method providing image stream restoration.

58. A method as claimed in claim 47 further comprising:
determining whether said anchor frame and said target frame correspond to a scene change; and
generating said interpolated frame including repeating one of said anchor frame and said target frame if said anchor frame and said target frame correspond to said scene change.

59. A method for interpolating at least one image between an anchor frame and a target frame of an image stream having an initial frame rate, said method comprising:
defining a plurality of blocks at least in said anchor frame;
obtaining at least one block-based motion vector for each anchor frame block by comparing image information in each anchor frame block to image information in said target frame;
generating at least one trial interpolated frame based on said at least one motion vector, said trial interpolated frame having a plurality of blocks;
identifying pixel interpolation errors to detect pixels associated with interpolation artifacts; and
regenerating pixels exhibiting interpolation artifacts based on image information from interpolated frame blocks adjacent to pixels exhibiting artifacts to minimize said interpolation artifacts.

60. A method as claimed in claim 59, each of said plurality of blocks further comprising an overscan region about said block, said regenerating further comprising blending at least one overscan portion of said adjacent interpolated frame blocks.

61. A method as claimed in claim 59 further comprising reducing a number of detected pixels associated with interpolation artifacts to a number of pixels exhibiting interpolation artifacts by employing a smoothing out process in order to improve interpolated image sharpness.

62. A method as claimed in claim 61, said smoothing out process further comprising one of ignoring pixels having pixel matching errors disproportionate with pixel matching error of neighboring pixels and smoothing out edges of regions containing pixels associated with interpolation artifacts.

63. A method as claimed in claim 59, identifying pixel interpolation errors further comprising reverse mapping interpolated frame blocks to one of said anchor frame and said target frame using said motion vector.

64. A method as claimed in claim 59, wherein said plurality of blocks comprises a plurality of first level blocks having a common size, obtaining said at least one motion vector further comprises obtaining a motion vector set for variable-size sub-blocks within said first level block by comparing image information in each said sub-block to image information in said target frame.

65. A method as claimed in claim 59, said generating further comprising generating at least one temporal interpolated frame at an output frame rate different from said initial frame rate, said method providing frame rate conversion.

66. A method as claimed in claim 65, said output frame rate further comprising a lower frame rate compared to the initial frame rate providing frame rate down conversion.

67. A method as claimed in claim 65, said output frame rate further comprising a higher frame rate compared to the initial frame rate providing frame rate up conversion.

68. A method as claimed in claim 65, said method further comprising selecting said anchor image frame and said target image frame from the image stream about a frame time at said output frame rate.

69. A method as claimed in claim 59, wherein said anchor frame and said target frame comprise frames adjacent to at least one of a dropped frame, a missing frame and a degraded frame, said generating further comprising generating at said initial frame rate at least one temporal interpolated frame between said anchor and target frames, said method providing image stream restoration.

70. A method as claimed in claim 59 further comprising:
determining whether said anchor frame and said target frame correspond to a scene change; and
generating said interpolated frame including repeating one of said anchor frame and said target frame if said anchor frame and said target frame correspond to said scene change.
